(19) United States
(12) Patent Application Publication
(10) Pub. No.: US 2007/0274155 A1
(43) Pub. Date: Nov. 29, 2007

(54) Coding and Decoding: Seismic Data Modeling, Acquisition and Processing

(76) Inventor: Luc T. Ikelle, Bryan, TX (US)

Correspondence Address: Oppedahl Patent Law Firm LLC, P.O. BOX 4850, FRISCO, CO, 80443-4850, US

(21) Appl. No.: 11/748,473

(22) Filed: May 14, 2007

Related U.S. Application Data
(60) Provisional application No. 60/803,230, filed on May 25, 2006.
(60) Provisional application No. 60/894,182, filed on Mar. 9, 2007.
(60) Provisional application No. 60/894,685, filed on Mar. 14, 2007.

(51) Int. Cl. G01V 1/28; G01V 1/00

(52) U.S. Cl. 367/38

(57) ABSTRACT

A method for coding and decoding seismic data acquired, based on the concept of multishooting, is disclosed. In this concept, waves generated simultaneously from several locations at the surface of the earth, near the sea surface, at the sea floor, or inside a borehole propagate in the subsurface before being recorded at sensor locations as mixtures of various signals. The coding and decoding method for seismic data described here works with both instantaneous mixtures and convolutive mixtures. Furthermore, the mixtures can be underdetemined [i.e., the number of mixtures (K) is smaller than the number of seismic sources (I) associated with a multishot] or determined [i.e., the number of mixtures is equal to or greater than the number of sources). When mixtures are determined, we can reorganize our seismic data as zero-mean random variables and use the independent component analysis (ICA) or, alternatively, the principal component analysis (PCA) to decode. We can also alternatively take advantage of the sparsity of seismic data in our decoding process. When mixtures are underdetermined and the number of mixtures is at least two, we utilize higher-order statistics to overcome the underdeterminacy. Alternatively, we can use the constraint that seismic data are sparse to overcome the underdeterminacy. When mixtures are underdetermined and limited to single mixtures, we use a priori knowledge about seismic acquisition to computationally generate additional mixtures from the actual recorded mixtures. Then we organize our data as zero-mean random variables and use ICA or PCA to decode the data. The a priori knowledge includes source encoding, seismic acquisition geometries, and reference data collected for the purpose of aiding the decoding processing.

The coding and decoding processes described can be used to acquire and process real seismic data in the field or in laboratories, and to model and process synthetic data.

This application claims the benefit of U.S. application No. 60/894,685 filed Mar. 14, 2007, and of U.S. application No. 60/803,230 filed May 25, 2006, and of U.S. application No. 60/894,182 filed Mar. 9, 2007, each of which is hereby incorporated herein by reference for all purposes.

### 1 INTRODUCTION

Thanks to these coding and decoding processes, a single channel can pass several independent messages simultaneously, thus improving the economics of the line. These processes are widely used in cellular communications today so that several subscribers can share the same channel. One classic implementation of these processes consists of dividing the available frequency bandwidth into several disjointed smaller-frequency bandwidths. Each user is allocated a separate frequency bandwidth. The voice signals of all users sharing the telephone line are then combined into one signal (coding process) in such a way that they can easily be recovered. The combined signal is transmitted through the channel. The disjointing of bandwidths is then used at the receiving end of the channel to recover the original voice signals (the decoding process). Our objective in this invention is to adapt coding and decoding processes to seismic data acquisition and processing in an attempt to further improve the economics of oil and gas exploration and production.

Our basic idea in this invention is to acquire seismic data by generating waves from several locations simultaneously instead of from a single location at a time, as is currently the case. Waves generated simultaneously from several locations at the surface of the earth or in the water column at sea propagate in the subsurface before being recorded at sensor locations. The resulting data represent coded seismic data. The decoding process then consists of reconstructing data as if the acquisition were performed in the present fashion, in which waves are generated from a single shot location, and the response of the earth is recorded before moving to the next shot location.

We call the concept of generating waves simultaneously from several locations simultaneous multishooting, or simply multishooting. The data resulting from multishooting acquisition will be called multishot data, and those resulting from the current acquisition approach, in which waves are generated from one location at a time, will be called single-shot data. So multishot data are the coded data, and the decoding process aims at reconstructing single-shot data.

There are significant differences between the decoding problem in seismics and the decoding problem in communication theory. In communication, the input signals (i.e., voice signals generated by subscribers who are sharing the same channel) are coded and combined into a single signal which is then transmitted through a relatively homogeneous medium (channel) whose properties are known. Although the input signals are very complex, the decoding process in communication is quite straightforward because the coding process is well known to the decoders, as are most changes to the signals during the transmission process.

In seismics, the input signals generated by seismic sources are generally simple. But they pass through the subsurface, which can be a very complex heterogeneous, anisotropic, and anelastic medium and which sometimes exhibits nonlinear elastic behaviors—a number of coding features are lost during the wave propagation through such media. Moreover, the fact that this medium is unknown significantly complicates the decoding problem in seismics compared to the decoding problem in communication. Signals received after wave propagation in the subsurface are also as complex as those in communication. However, they contain the information about the subsurface that we are interested in reconstructing. The decoding process in this case consists of recovering the impulse response of the earth corresponding to each of the sources of the multishooting experiment.

Over the last four decades, seismic imaging methods have been developed for data acquired only sequentially, one shot location after another (i.e., single-shot data).

Therefore, multishot data must be decoded in order to image them with present imaging technology until new seismic-imaging algorithms for processing multishot data without decoding are developed. In this invention, we describe in more detail the challenges of decoding multishot data as well as the approaches we will follow in subsequent later sections for addressing these challenges.

### SUMMARY

Referring now to FIG. 11, two approaches for data gathering and analysis are described.

FIG. 11(a) shows a common way in which data gathering and analysis has been done in the prior art. A single shot acquisition is carried out and data are gathered (101), which may be over land or water. Any of a variety of well-known imaging software may be used to analyze the single-shot data (102). Imaged results are obtained, and in this way subsurface features are identified.

FIG. 11(b) shows an embodiment of the invention. Instead of a single shot acquisition, what is carried out is a multishot, with collection of multishot data (103). Importantly, the multishot data are then decoded (104) as described in detail herewithin. This yields a data set (here called a “proxy single-shot data”) which can then be fed to any of the variety of well-known imaging software as if it were single-shot data. The result, as in FIG. 11(a) is development of imaged results.

As will be appreciated, what is described is a method of subsurface exploration using seismic or/and EM data. The method calls for a sequence of steps.

First, we acquire multisweep-multishot data generated from several points nearly simultaneously. The acquisition can be carried out onshore or offshore. Alternatively, multisweep-multishot data can generated by computer simulation. We denote by K the number of sweeps and by I the number of shot points for each multishot location.

If K=1 (that is, if only one sweep is acquired using for example one shooting boat towing a set of airgun arrays), then we numerically generate at least one additional sweep. The additional sweep is generated using time delay (algorithms 7, 9, 10 and 11), reference shot data (algorithm 8), or multicomponent data (algorithms 12 and 13).

If K=I, and a mixing matrix is known, then we perform the inversion of the mixing matrix to recover the single-shot data.

If K=I, and a mixing matrix is not known, then we use the PCA or/and ICA to recover the single-shot data (algorithms 1, 2, 3, and 4) for instantaneous mixtures and algorithm 5 for convolutive mixtures.

If K<I (with K equaling at least 2), then we use algorithm 6.

### FIGURES

FIG. 1: Examples of the two types of source signatures encountered in seismic surveys: (a) the short-duration source signature such as the one used in FIGS. 2 and 3 and (b) the long-continuous source signature in the form of the Chirp function.

FIG. 2: Snapshots of wave propagation in which four shots are fired simultaneously from four points spaced 50 m apart. The source signature is the same for the four shots, but their initial firing times are different.

FIG. 3: An example of a multishot gather corresponding to the experiment described in FIG. 2.

FIG. 4: Schematic diagrams illustrating the coding and decoding processes for seismic data processing. We first generate multisweep-multishot (MW/MX) data. Then we seek a demixing matrix that allows us to recover the single-shot gathers from MW/MX data.

FIG. 5: The scatterplots of (left) the mixtures, (middle) whitened data, and (right) decoded data. We used seismic data in FIG. 6.

FIG. 6: Examples of two mixtures of seismic data.

FIG. 7: Whitened data of the mixtures of seismic data in FIG. 6.

FIG. 8: The seismic decoded data. We have effectively recovered the original single-shot data.

FIG. 9: Multisweep-multishot data obtained mixtures of four single-shot gathers with 125-m spacing between two consecutive shot points.

FIG. 10: The results of decoding the data in FIG. 9. We have effectively recovered the original single-shot data.

FIG. 11: FIG. 11(a) shows diagrammatically as a flowchart a common way in which data gathering and analysis has been done in the prior art. FIG. 11(b) shows an embodiment of the invention.

### DETAILED DESCRIPTION

### 2 AN ILLUSTRAION OF THE CONCEPT OF MULTISHOOTING

### 2.1 An Example of Multishot Data

Multishooting acquisition consists of generating seismic waves from several positions simultaneously or at time intervals smaller than the duration of the seismic data. To fix our thoughts, let us consider the problem of simulating I shot gathers. Although the concept of multishooting is valid for the full elastic wave equation, for simplicity we limit our mathematical description in this section to the acoustic wave equation of 2D media with constant density.

Let (x,z) denote a point in the medium with a velocity c(x,z), (xᵢ,zᵢ) denote a source position, Pᵢ(x,z,t) denote the pressure variation at point (x,z), and time t for a source at (xᵢ,zᵢ). The problem of simulating a seismic survey of I shot gathers corresponds to solving the differential equation

$$\begin{matrix}( \frac{1}{{c}^{2} ( x , z )} \frac{{\partial }^{2}}{\partial {t}^{2}} - [ \frac{{\partial }^{2}}{\partial {x}^{2}} + \frac{{\partial }^{2}}{\partial {z}^{2}} ] ) & ( 1.1 ) \\ {P}_{i} ( x , z , t ) = {a}_{i} ( t ) δ ( x - {x}_{i} ) δ ( z - {z}_{i} ) , & \\ with & \\ {P}_{i} ( x , z , t ) = 0 , if t \leq 0. & ( 1.2 )\end{matrix}$$

The subscript i varies from 1 to I. The function aᵢ(t) represents the source signature for the i-th shot.

For multishooting, we must solve the following equation:

$$\begin{matrix}( \frac{1}{{c}^{2} ( x , z )} \frac{{\partial }^{2}}{\partial {t}^{2}} - [ \frac{{\partial }^{2}}{\partial {x}^{2}} + \frac{{\partial }^{2}}{\partial {z}^{2}} ] ) & ( 1.3 ) \\ P ( x , z , t ) = {\sum }_{i = 1}^{I} {a}_{i} ( t ) δ ( x - {x}_{i} ) δ ( z - {z}_{i} ) , & \\ with & \\ P ( x , z , t ) = 0 and {a}_{i} ( t ) = 0 , if t \leq 0 , & ( 1.4 )\end{matrix}$$

where all the I shots are generated simultaneously [or almost simultaneously if there is a slight delay between the aᵢ(t)] and recorded in a single shot gather. We will call the wavefield P(x,z,t) the multishot data.

One of the key tasks in generating multishot data is the process of distinguishing the source signatures, aᵢ(t). This process is known as source encoding. Source encoding can consist simply of slight variation in the initial firing time of the sources involved in the multishooting experiment. Such variations must take into account the record length of the data, the distance between two multishots, and for marine data, the boat ship speed (˜3 m/s).

Let us look at an example of a multishot gather made up of four shot gathers for the case in which the source signatures aᵢ(t) are selected as follows:

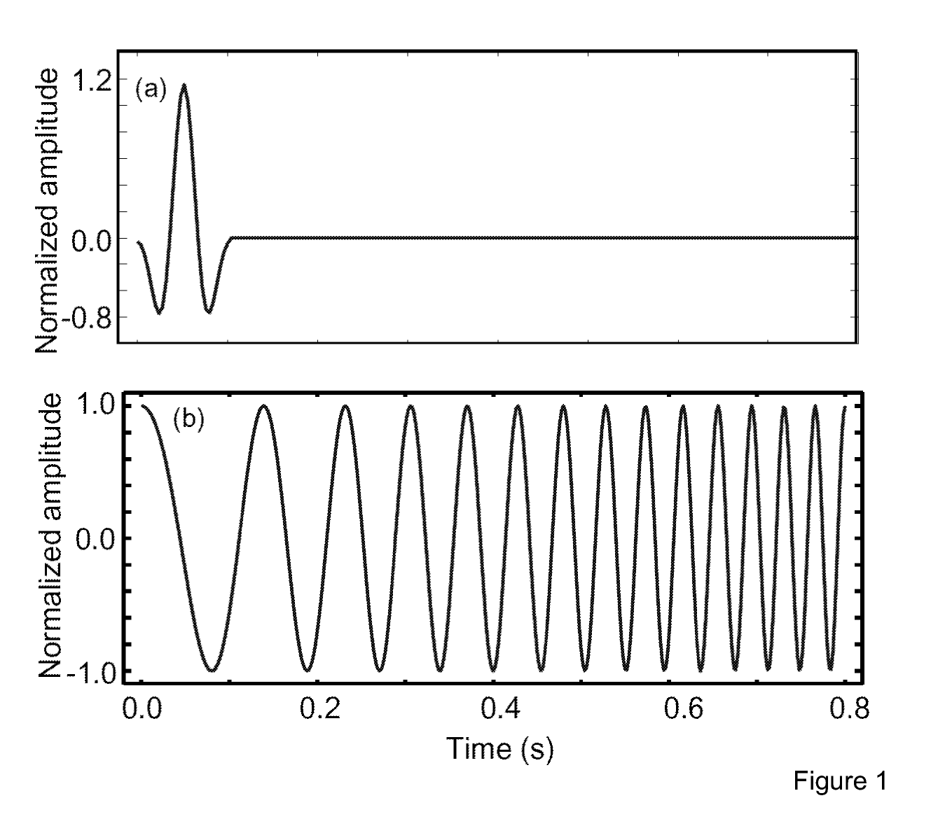

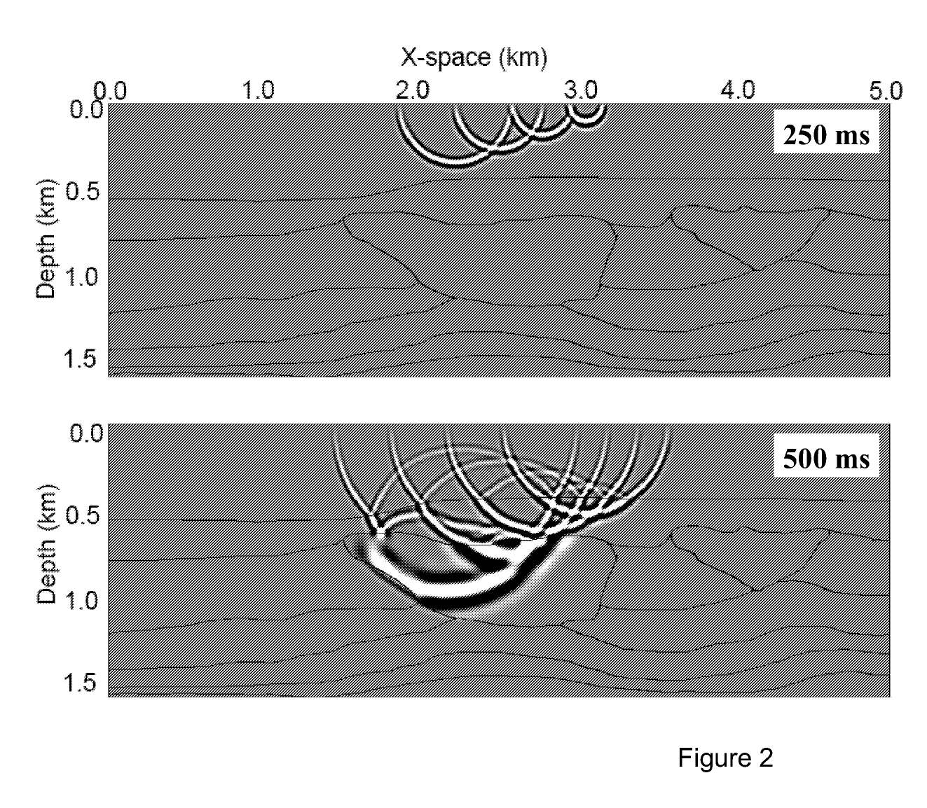

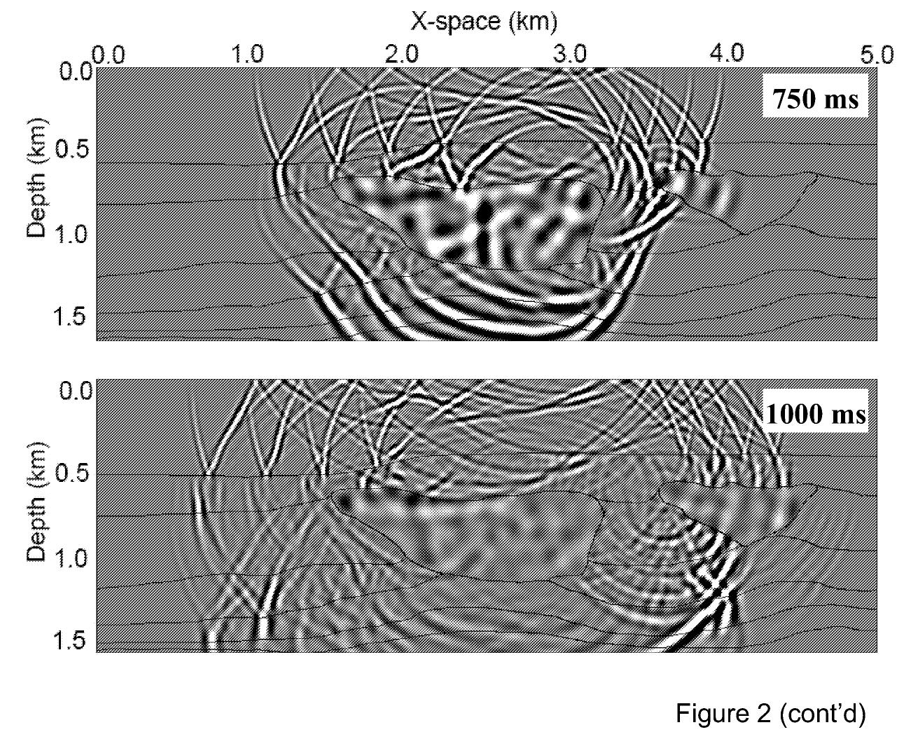

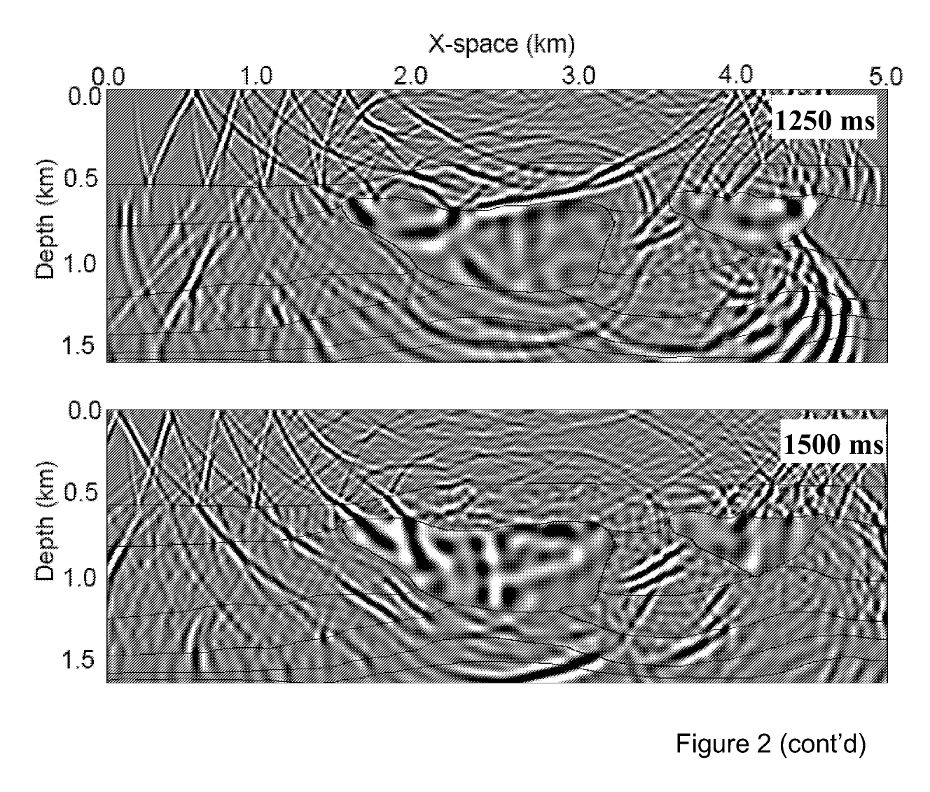

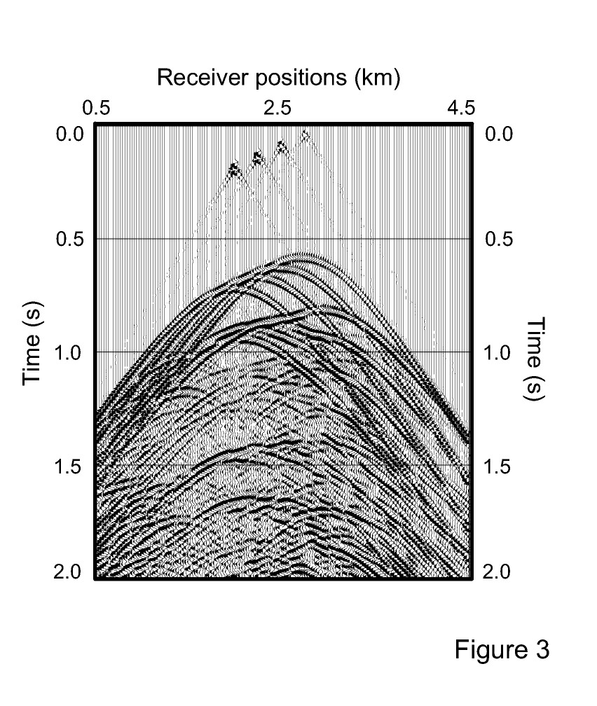

aᵢ(t)=g(t−τᵢ), (1.5)

where g(t) is the source signature in FIG. 1 and τᵢ is the time at which shot i is fired. In other words, the source signatures are identical for all four shots, but they have different initial firing times (i.e., τ₁=0, τ₂=100 ms, τ₃=200 ms, τ₄=300 ms). The firing-time delays have been made quite large in this example to facilitate the analysis of the first example of multishot data for this invention The four shot points are (x₁=2250 m, z₁=10 m), (x₂=2500 m, z₂=10 m), (x₃=2750 m, z₃=10 m), and (x₄=3000 m, z₄=10 m). FIG. 2 shows the snapshots of the wave propagation of a time-coded multishot wavefield. At t=250 ms, all the waves created by each of the four shots are clearly distinguishable. However, for later times, such as t=1000 ms, it is more difficult to distinguish waves associated with each of the four shots because multiple reflections and diffractions have significantly distorted the wavefronts. Similar observations can be made for multishot gathers in FIG. 3. Early-arrival events, such as direct waves associated with the four shots, are clearly distinguishable and can easily be decoded. It is more difficult, at least visually, to establish the association of late-arrival events with particular shot points.

### 2.2 The Principle of Superposition in Multishooting

As illustrated in FIGS. 2 and 3, the concept of multishooting is based on the principle of superposition; i.e., multishot gather P(x,z,t) is related to single-shot gathers Pᵢ(x,z,t), as follows (1.1):

$$P ( x , z , t ) = {\sum }_{i = 1}^{I} {P}_{i} ( x , z , t - {τ}_{i} ) . \qquad ( 1.6 )$$

This principle states that in a linear system, the response to a number of signal inputs, applied nearly simultaneously, is the same as the sum of the responses to the signals applied separately (one at a time). In the context of multishooting, the input signals are source signatures (the source signatures need not be identical; for instance, their initial firing times can be different, as shown in FIG. 3). The linear system satisfies the linear stress-strain relation and the equations of motion from which we derive wave equations such as the ones in (1.1) and (1.3). The pressure response, P(x,z,t), can be either snapshots (at t=constant) or seismic data (at z=constant) representing stress, particle velocity, particle acceleration, etc. So the only time the superposition principle does not apply to our multishooting concept occurs when a system is nonlinear—for example, when the stress-strain relation is nonlinear, as the equilibrium equation is valid for any medium, linear or nonlinear. Fortunately, the linear stress-strain relation is good enough for modeling most phenomena encountered in seismic data because in petroleum seismology we are primarily dealing with small deformations (in both stresses and strains).

The only phenomenon of importance in seismic exploration and production that may be properly modeled by a linear stress-strain relation is the deformation near the shot point during the formation of the initial shot pulse because the deformation in the vicinity of the shot point can be relatively large. But this phenomenon does not appear to be of great consequence over most of the travelpath, thus permitting us to use the superposition principle in most cases.

### 3 THE REWARDS OF MULTISHOOTING

The potential savings in time and money associated with multishooting are enormous, because the cost of simulating or acquiring numerous shots simultaneously is almost identical to the cost of simulating and acquiring one shot. Let us elaborate on these potential savings for (1) seismic acquisition, (2) numerical simulation of seismic surveys, and (3) data storage.

### 3.1 Seismic Acquisition

It is obvious that multishooting can reduce the cost of and the time required for the present acquisition procedure severalfold. However, it can also be used to improve the ways in which we acquire data. For instance, it can be used to improve the spacing between shot points, especially the azimuthal distribution of shot points, and therefore to collect true 3D data (i.e., the full-azimuth survey). In fact, current 3-D acquisitions-say, marine, with a shooting boat sailing along in one direction and shooting only in that direction-do not allow enough spacing between shot points for a full azimuthal coverage of the sea surface or land surface.

The multishooting concept can also be used to improve inline coverage in marine acquisitions. A typical shooting boat tows two sources that are fired alternatively every 25 m (i.e., individually every 50 m), allowing us to record data more quickly than when only one source is used. As we mention earlier, this shooting technique is known as flip-flop. The drawback of flip-flop shooting is that the spacing between shots is 50 m, but most modern seismic data-processing tools, which are based on the wave equation, require a spacing on the order of 12.5 m or less. By replacing each source with an array of four sources separated by 12.5 m, we can produce a dataset with a source spacing of 12.5 m. We can actually replace each source with an array of several sources (more than four). Such an array leads to a multishooting survey. So instead of the shooting boat towing two sources, it will tow several sources, just as it is presently towing several streamers. The present technology for synchronizing the shooting time and orienting vessels and streamer positions can be used to deploy and fire these sources at the desired space and time intervals.

### 3.2 Simulation of Seismic Surveys

Simulating seismic surveys corresponds to solving the differential equations which control the wave propagation in the earth under a set of initial, final, and boundary conditions. The most successful numerical techniques for solving these differential equations include (i) finite-difference modeling (FDM) based on numerical approximations of derivatives, (ii) ray-tracing methods, (iii) reflectivity methods, and (iv) scattering methods based on the Born or Kirchhoff approximations. These techniques differ in their regime of validity, their cost, and their usefulness in the development of interpretation tools such as inversion. When an adequate discretization in space and time, which permits an accurate computation of derivatives of the wave equation, is possible, the finite-difference modeling technique is the most accurate tool for numerically simulating elastic wave propagation through geologically complex models (e.g., Ikelle et al., 1993).

Recently, more and more engineers and interpreters in the industry and even in field operations are using the two-dimensional version of FDM to simulate and design seismic surveys, test imaging methods, and validate geological models. Their interest is motivated by the ability of FDM to accurately model wave propagation through geologically complex areas. Moreover, it is often very easy to use. However, for FDM to become fully reliable for oil and gas exploration and production, we must develop cost-effective 3D versions.

3D-FDM has been a long-standing challenge for seismologists, in particular for petroleum seismologists, because their needs are not limited to one simulation but apply to many thousands of simulations. Each simulation corresponds to a shot gather. To focus our thoughts on the difficulties of the problem, let us consider the simulations of elastic wave propagation through a complex geological model discretized into 1000×1000×500 cells (Δx=Δy=Δz=5 m). The waveforms are received for 4,000 timesteps (Δt=1 ms). We have estimated that it will take more than 12 years of computation time using an SGI Origin 2000, with 20 CPUs, to produce a 3D survey of 50,000 shots. For this reason, most 3D-FDM has been limited to borehole studies (at the vicinity of the well), in which the grid size is about 100 times smaller than that of surface seismic surveys (Cheng et al., 1995). One alternative to 3D-FDM generally put forward by seismologists is the hybrid method, in which two modeling techniques (e.g., the ray-tracing and finite-difference methods) are coupled to improve the modeling accuracy or to reduce the computation time. For complex geological models containing significant lateral variations, this type of coupling is very difficult to perform or operate. Moreover, the connectivity of the wavefield from one modeling technique to another sometimes produces significant amplitude errors and even phase distortion in data obtained by hybrid methods. We describe here a computational method of FDM which significantly reduces the cost of producing seismic surveys, in particular 3D seismic surveys. Instead of performing FDM sequentially, one shot after another, as is currently practiced, we will compute several shots simultaneously, then decode them if necessary. The cost of computing several shots simultaneously is identical to the cost of computing one shot. As we will see later, the fundamental problem is how to decode the various shot gathers if we are using a processing package which requires the shot gathers to be separated, or how to directly process multishot data.

### 3.3 Seismic Data Storage

The cost of storing seismic data is almost as important as that of acquiring and processing seismic data. Today a typical 3D seismic survey amounts to about 100 Tbytes of data. On average, about 200 such surveys are acquired every month. And all these data must not only be processed, but they are also digitally stored for several years, thus making the seismic industry one of the biggest consumers of digital storage devices. The concept of multishooting allows us to reduce the requirements of seismic-data storage by severalfold. For instance, in the case of a multishooting acquisition in which eight shot gathers are acquired simultaneously, we can reduce the data storage from 100 Tbytes to 12.5 Tbytes.

### 4 THE CHALLENGES OF MULTISHOOTING

Several hurdles must be overcome before the oil and gas industry can enjoy the benefits of multishooting in the drive to find cost-effective E&P (exploration and production) solutions. Fundamental among these hurdles are the following:
how to collect multishot data
how to simulate multishot data on the computer
how to decode multishot data

Addressing these issues basically involves developing methods for decoding multishot data. These developments will in turn dictate how to collect and simulate multishot data or, in other words, how sources must be encoded [e.g., how to select parameters aᵢ(t) and τᵢ].

### 4.1 Decoding of Multishot Data

Let us now turn to the decoding problem. To understand the challenges of decoding seismic data, let us consider a multishooting acquisition with I source points {(x₁,z₁), (x₂,z₂), . . . , (x_{I},z_{I})}, which are associated with I source signatures a₁(t), a₂(t), . . . , a_{I}(t). The multishot data at a particular receiver can be written as follows:

$$\begin{matrix}P ( {x}_{r} , t ) = {\sum }_{i = 1}^{I} {P}_{i} ( {x}_{r} , t ) \\ = {\sum }_{i = 1}^{I} {a}_{i} ( t ) * {H}_{i} ( {x}_{r} , t ) \\ = {\sum }_{i = 1}^{I} [ {\int }_{- ∞}^{∞} {a}_{i} ( τ ) {H}_{i} ( {x}_{r} , t - τ ) d τ ] ,\end{matrix} \qquad ( 1.7 )$$

where P(xᵣ,t) are the multishot data and Pᵢ(xᵣ,t) are the single shot gathers with the shot point at (xᵢ,zᵢ). Hᵢ(xᵣ,t) is the earth's impulse response at the receiver location xᵣ and the shot point at (xᵢ,zᵢ) for the case in which aᵢ(t) is the source function. The star * denotes the time convolution. The seismic decoding problem is generally that of estimating either (1) the single-shot data Pᵢ(xᵣ,t) or (2) the source signatures aᵢ(t) and the impulse responses Hᵢ(xᵣ,t), as in most situations the source signatures are not accurately known.

Even if the source signatures are available for each timestep, we still have to solve for I unknowns [Hᵢ(xᵣ,t)] from one equation for each timestep. So one of the key challenges of seismic decoding is to construct additional equations to (1.7) without performing new multishot experiments. In other words, we have to go from (1.7) to either

$$\begin{matrix}{Q}_{k} ( {x}_{r} , t ) = {\sum }_{i = 1}^{I} {A}_{ki} ( t ) * {H}_{i} ( {x}_{r} , t ) & ( 1.8 ) \\ or & \\ {Q}_{k} ( {x}_{r} , t ) = {\sum }_{i = 1}^{I} {γ}_{ki} {P}_{i} ( {x}_{r} , t ) . & ( 1.9 )\end{matrix}$$

where the subscript k varies from 1 to K, with K=I. Each k corresponds to the construction of a multishooting experiment from (1.7), with Qₖ(xᵣ,t) being the resulting multishot data. We will characterize the multishooting experiments corresponding to data Q₁(xᵣ,t), Q₂(xᵣ,t), . . . , Q_{K}(xᵣ,t) as multisweep/multishot data, where the subscript k describes the various sweeps and the subscript i in equations (1.8) and (1.9) describes single-shot gathers which have been combined to form the multishot data. In short, we will call the multisweep/multishot data MW/MX, where MW stands for multisweep and MX for multishot. We have selected the nomenclature MW/MX to avoid any confusion with the MS/MS nomenclature, which is known in the seismic community as the multisource/multistreamer. So in (1.8), the MW/MX data are obtained as instantaneous mixtures of the single-shot data, whereas in (1.9) they are obtained as convolutive mixtures of the single-shot data.

With this notation, the problem of going from (1.82) to, say, (1.9) corresponds to constructing MW/MX data from single-sweep/multishot data, which we will denote (SW/MX). Later on, we describe several ways of constructing MW/MX data from SW/MX data by mainly using (1) source encoding, (2) acquisition geometries, and (3) the sparsity of seismic data.

In this invention, we address the general decoding problem in which the starting points are K sweep data with K≦I. When K<I, we use source encoding, acquisition geometries, and classic processing tools to construct the additional I−K equations. The case in which K=1 (SW/MX) is just one particular case.

Very often, the matrices in equations (1.8) and (1.9) are unknown. We will denote the matrix in (1.9) Γ and the matrix in (1.8) A, We call them mixing matrices. Earlier, we described ways of solving the system in (1.9)—that is, of simultaneously estimating the mixing matrix Γ (or its inverse), and the single-shot gathers, Pᵢ(xᵣ,t). Later on we describe solutions of the system in (1.8)—that is, the simultaneous estimation of the mixing matrix A (or its inverse) and the impulse responses Hᵢ(xᵣ,t).

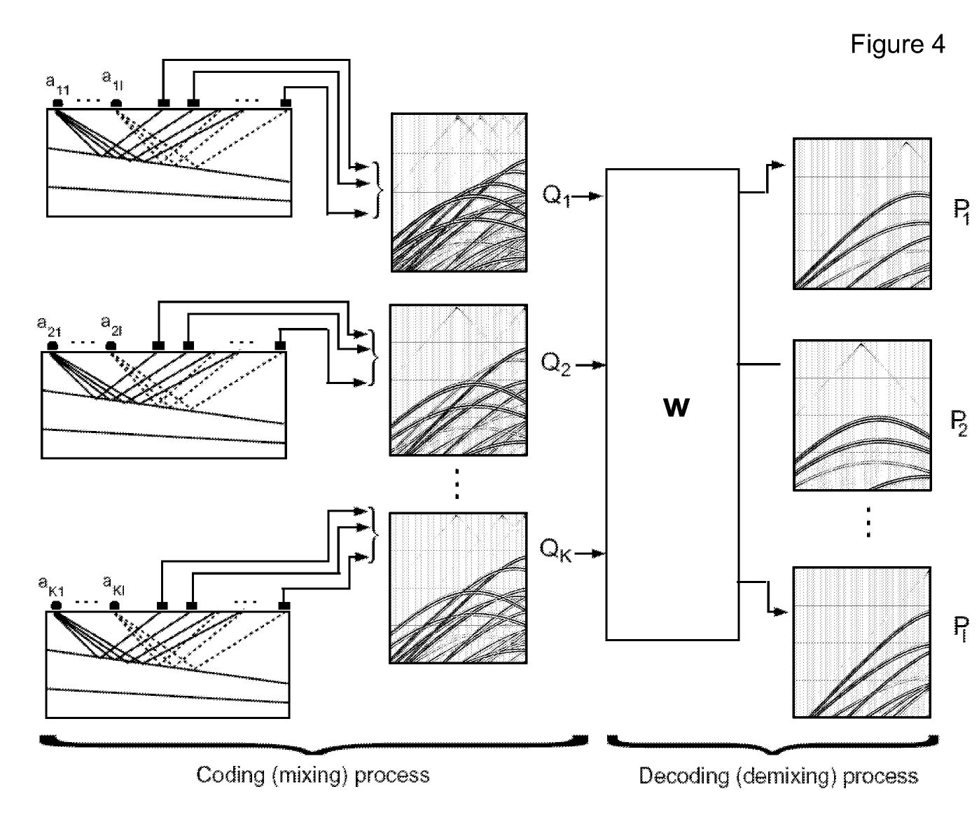

To summarize the key steps of the coding and decoding processes that we have just defined, we have schematized them in FIG. 4. Note that the coding process—that is, the process of generating and/or constructing MW/MX data—is considered synonymous with the coding process in this figure and in the rest of the invention. Similarly, the decoding process—that is, the process of constructing single-shot data from MW/MX data—and the demixing processes are used synonymously in this figure and in the rest of the invention.

### 5 BACKGROUND

(1.) Related to US patent, U.S. Pat. No. 6,327,537 B1

(2.) Basseley et al. (U.S. Pat. No. 5,924,049) propose a method for acquiring and processing seismic survey data from two or more sources activated simultaneously or near simultaneously. Their method (i) requires two or more vessels, (ii) is limited to a 1D model of the surface (although not explicitly stated), (iii) does not utilize ICA or PCA, and (iv) is limited to instantaneous mixtures.

(3.) Salla et al. (U.S. Pat. No. 6,381,544 B1) propose a method designed for vibroseis acquisition only. Their method (i) does not utilize ICA or PCA, (ii) is limited to instantaneous mixtures, and (iii) assumes that the mixing matrices are instantaneous and known.

(4.) Douma (U.S. Pat. No. 6,483,774 B2) presents an invention for acquiring marine data using a seismic acquisition system in which shot points are determined and shot records are recorded. The method differs from ours in that (i) it is not a multishooting acquisition as defined here, and (ii) it does not utilize ICA or PCA.

(5.) Sitton (U.S. Pat. No. 6,522,974 B2) describes a process for analyzing, decomposing, synthesizing, and extracting seismic signal components such as the fundamentals of a pilot sweep or its harmonics, from seismic data uses a set of basis functions. This method (i) is not a multishooting acquisition as defined here, (ii) it does not utilize ICA or PCA, and (iii) it is for vibroseis acquisition only.

(6.) de Kok (U.S. Pat. No. 6,545,944 B2) describes a method of seismic surveying and seismic data processing using a plurality of simultaneously recorded seismic-energy sources. This method focuses more on a specific design of multishooting acquisition and not on decoding. It does not consider convolutive mixtures, it does not utilize ICA or PCA, and it assumes that the mixing matrices are known.

(7.) Moerig et al. (U.S. Pat. No. 6,687,619 B2) describe a method of seismic surveying using one or more vibrational seismic energy sources activated by sweep signals. Their method (i) does not utilize ICA or PCA, (ii) it is limited to instantaneous mixtures with the Walsh type of code, (iii) is limited to vibroseis acquisition only, and (iv) it assumes that the mixing matrices are known.

(8.) Becquey (U.S. Pat. No. 6,807,508 B2) describes a seismic prospecting method and device for simultaneous emission, by vibroseis, of seismic signals obtained by phase modulating a periodic signal. This method (i) does not utilize ICA or PCA, (ii) is limited to instantaneous mixtures with the Walsh type of code, (iii) is limited to vibroseis acquisition only, and (iv) assumes that the mixing matrices are known.

(9.) Moerig et al. (U.S. Pat. No. 6,891,776 B2) describe methods of shaping vibroseis sweeps. This method (i) is not a multishooting acquisition as defined here, (ii) does not utilize ICA or PCA, and (iii) is for vibroseis acquisition only.

(10.) Most seismic coding and decoding methods as focused so far on vibroseis sources using some forms of Walsh-Hadamard codes. The Walsh-Hadamard code of length I=2^{m} is a set of perfectly orthogonal sequences that can be defined and generated by the rows of the 2^{m}×2^{m} Hadamard matrix (Yarlagadda and Hershey, 1997). Starting with a 1×1 matrix, Γ₁=[1] (i.e., m=0), higher-order Hadamard matrices can be generated by the following recursion:

$${Γ}_{{2}^{m}} = [ \begin{matrix}{Γ}_{{2}^{m - 1}} & {Γ}_{{2}^{m - 1}} \\ {Γ}_{{2}^{m - 1}} & - {Γ}_{{2}^{m - 1}}\end{matrix} ] . \qquad ( 1.10 )$$

For example, Γ₈ can be recursively generated as

$$\begin{matrix}{Γ}_{2} = [ \begin{matrix}+ 1 & + 1 \\ + 1 & - 1\end{matrix} ] & ( 1.11 ) \\ for I = 2 ( i . e . , m = 1 ) , & \\ \begin{matrix}{Γ}_{4} = [ \begin{matrix}{Γ}_{2} & {Γ}_{2} \\ {Γ}_{2} & - {Γ}_{2}\end{matrix} ] \\ = [ \begin{matrix}+ 1 & + 1 & + 1 & + 1 \\ + 1 & - 1 & + 1 & - 1 \\ + 1 & + 1 & - 1 & - 1 \\ + 1 & - 1 & - 1 & + 1\end{matrix} ]\end{matrix} & ( 1.12 ) \\ for I = 4 ( i . e . , m = 2 ) & \\ \begin{matrix}{Γ}_{8} = [ \begin{matrix}{Γ}_{4} & {Γ}_{4} \\ {Γ}_{4} & - {Γ}_{4}\end{matrix} ] \\ = [ \begin{matrix}+ 1 & + 1 & + 1 & + 1 & + 1 & + 1 & + 1 & + 1 \\ + 1 & - 1 & + 1 & - 1 & + 1 & - 1 & + 1 & - 1 \\ + 1 & + 1 & - 1 & - 1 & + 1 & + 1 & - 1 & - 1 \\ + 1 & - 1 & - 1 & + 1 & + 1 & - 1 & - 1 & + 1 \\ + 1 & + 1 & + 1 & + 1 & - 1 & - 1 & - 1 & - 1 \\ + 1 & - 1 & + 1 & - 1 & - 1 & + 1 & - 1 & + 1 \\ + 1 & + 1 & - 1 & - 1 & - 1 & - 1 & + 1 & + 1 \\ + 1 & - 1 & - 1 & + 1 & - 1 & + 1 & + 1 & - 1\end{matrix} ]\end{matrix} & ( 1.13 )\end{matrix}$$

for I=8 (i.e., m=4). All the row and column sequences of the Hadamard matrices are Walsh sequences if the order is I=2^{m}.

So the decoding of multishot data is facilitated by coding the polarities of source energy with the Walsh-Hadamard decoding. Let us consider the case in which two sources are twice simultaneously operated [i.e., I=2] to send waves into the subsurface. In the second sweep, each of the two sources sends energy identical to that in the first sweep, except that the polarity of the second source is opposite that of the first sweep. By substitution, we obtain those decoded data:

$$\begin{matrix}{X}_{1} ( {x}_{r} , t ) = \frac{1}{2} [ {Y}_{1} ( {x}_{r} , t ) + {Y}_{2} ( {x}_{r} , t ) ] , & ( 1.14 ) \\ {X}_{2} ( {x}_{r} , t ) = \frac{1}{2} [ {Y}_{1} ( {x}_{r} , t ) - {Y}_{2} ( {x}_{r} , t ) ] . & ( 1.15 )\end{matrix}$$

Martinez et al. (1987), Womack et al. (1988), and Ward et al. (1990) arrive at the same result by assuming that the first source is 180 degrees out of phase relative to the first sweep.

Similarly, we can decode multishot data composed of four sources which are simultaneously operated four times [i.e., I=4] to send four sweeps of vibrations into the subsurface. In the second, third, and fourth sweeps, each of the four sources sends energy identical to that in the first sweep, except that some polarities are different from those in the first sweep. The first row of the polarity matrix in (1.12) corresponds to the polarities of the four sources for the first sweep, the second row corresponds to the polarities of the four sources for the second sweep, and so on. By using (1.12), we obtain the following decoded data:

$$\begin{matrix}{X}_{1} ( {x}_{r} , t ) = \frac{1}{4} [ {Y}_{1} ( {x}_{r} , t ) + {Y}_{2} ( {x}_{r} , t ) + {Y}_{3} ( {x}_{r} , t ) + {Y}_{4} ( {x}_{r} , t ) ] , & ( 1.16 ) \\ {X}_{2} ( {x}_{r} , t ) = \frac{1}{4} [ {Y}_{1} ( {x}_{r} , t ) - {Y}_{2} ( {x}_{r} , t ) + {Y}_{3} ( {x}_{r} , t ) - {Y}_{4} ( {x}_{r} , t ) ] , & ( 1.17 ) \\ {X}_{3} ( {x}_{r} , t ) = \frac{1}{4} [ {Y}_{1} ( {x}_{r} , t ) + {Y}_{2} ( {x}_{r} , t ) - {Y}_{3} ( {x}_{r} , t ) - {Y}_{4} ( {x}_{r} , t ) ] , & ( 1.18 ) \\ {X}_{4} ( {x}_{r} , t ) = \frac{1}{4} [ {Y}_{1} ( {x}_{r} , t ) - {Y}_{2} ( {x}_{r} , t ) - {Y}_{3} ( {x}_{r} , t ) + {Y}_{4} ( {x}_{r} , t ) ] , & ( 1.19 )\end{matrix}$$

The methods, which are based on the Walsh-Hadamard codes, are by definition limited to vibroseis sources through which such codes can be programmed. Moreover, the mixture matrices are assumed to be known, and the mixtures are assumed to be instantaneous.

### 6 ALGORITHMS FOR INSTANTANEOUS MIXTURES

The relationship between multishot data and decoded data at receiver xᵣ and time t can be written as follows:

$${Y}_{k} ( {x}_{r} , t ) = {\sum }_{i = 1}^{I} {γ}_{ki} {X}_{i} ( {x}_{r} , t ) , \qquad ( 1.20 )$$

where Yₖ(xᵣ,t) are the multishot data corresponding to the kth sweep and Xᵢ(xᵣ,t) correspond to the ith shot point if the acquisition was performed conventionally, one shot after another. Γ={γₖᵢ} is an I×I matrix (known as a mixing matrix) that we assume to be time- and receiver-independent. We will discuss this assumption and the content of this matrix in more detail later on. Again, the goal of the decoding process is to recover Xᵢ(xᵣ,t) from Yₖ(xᵣ,t), assuming that Γ is unknown.

As described in equation (1.20), the coding of multishot data [i.e., the construction of Yₖ] is actually independent of time and receiver locations. In other words, the way the single-shot data are mixed to construct multishot data at a data point, say, (xᵣ,t), is exactly the same at another data point, say, (x′ᵣ,t′). Therefore, as far as the coding and decoding of multishot data are concerned, each data point is only one possible outcome of seismic data-acquisition experiments.

Note that we can also use random vectors to describe seismic data in the context of the equation in (1.20). Suppose that we have performed I multishoot shot gathers {Yₖ(xᵣ,t), k=1, . . . , I} corresponding to I multishooting experiments. Statistically, we will describe the I multishot gathers as an I-dimensional random vector

Y=[Y₁,Y₂, . . . ,Y_{I}]^{T}, (1.21)

where T denotes the transpose. (Again, we use the transpose because all vectors in this invention are column vectors. Note also that vectors are denoted by boldface letters.) The components Y₁, Y₂, . . . , Y_{I} of the column vector Y are continuous random variables. Similarly, we can define a random vector

X=[X₁,X₂, . . . ,X_{I}]^{T} (1.22)

so that (1.20) can be written as follows:

Y=ΓX. (1.23)

### 6.1 Whitening

The decoding of seismic data will consist of going either from (i) dependent and correlated mixtures if the mixing matrix is nonorthogonal or from (ii) dependent and correlated mixtures if the mixing matrix is orthogonal to independent single-shot gathers. To facilitate the derivations of the decoding methods, we here describe a preprocessing of mixtures that allows us to turn the decoding process into a single problem of decoding data from mixtures that are not dependent but are uncorrelated. In other words, if the mixing matrix is not orthogonal, as is true in most realistic cases, we have to uncorrelate the mixtures before decoding. This process of uncorrelating mixtures is known as whitening.

So our objective in the whitening process is to go from multisweep-multishot gathers describing mixtures which are correlated and dependent to new multisweep-multishot gathers which correspond to mixtures that are uncorrelated but remain statistically dependent. Mathematically, we can describe this process as finding a whitening matrix V that allows us to transform the random vector Y (representing multisweep-multishot data) to another random vector, Z=[Z₁, Z₂, . . . , Z_{I}]^{T}, corresponding to whitened multisweep-multishot data; i.e.,

$${Z}_{i} = {\sum }_{k = 1}^{I} {υ}_{ik} {Y}_{k .} \qquad ( 1.24 )$$

Again, V={νᵢₖ} is an I×I matrix that we assume to be time- and receiver-independent. Based on the whitening condition, the whitening problem comes down to finding a V for which the covariance matrix of Z is the identity matrix; i.e.,

C_{Z}⁽²⁾=E[ZZ^{T}]=I. (1.25)

That is, the random variables of Z have a unit variance in addition to being mutually uncorrelated. Using (1.24), we can express the covariance of Z as a function of V and of the covariance of Y:

C_{Z}⁽²⁾=E[ZZ^{T}]=E[VYY^{T}V^{T}]=VC_{Y}⁽²⁾V^{T}=I. (1.26)

In general situations, the I sweeps of multishot data are mutually correlated; i.e., the covariance matrix C_{Y}⁽²⁾ is not diagonal. However, C_{Y}⁽²⁾ is always symmetric and positively definite. Therefore it can be decomposed using the eigenvalue decomposition (EVD), as follows:

C_{Y}⁽²⁾=E_{Y}L_{Y}^{-1/2}L_{Y}^{-1/2}E_{Y}^{T}, (1.27)

where E_{Y} is an orthogonal matrix and L_{Y} is a diagonal matrix with all nonnegative eigenvalues λᵢ; that is, L_{Y}=Diag(λ₁, λ₂, . . . , λₘ). The columns of the matrix E_{Y} are the eigenvectors corresponding to the appropriate eigenvalues. Thus, assuming that the covariance matrix is positively definite, the matrix V, which allows us to whiten the random vector Z, can be computed as follows:

V=L_{Y}^{-1/2}E_{Y}. (1.28)

Note that if we express the covariance of Y as

C_{Y}⁽²⁾=[C_{Y}⁽²⁾]^{1/2}[C_{Y}⁽²⁾]^{1/2} (1.29)

and substitute (1.29) into (1.26), we arrive at the classical alternative way of expressing V; that is, V=[C_{Y}⁽²⁾]^{-1/2}.

The whitened multisweep-multishot gathers are then obtained as

Z=VY. (1.30)

So the random vector Z is said to be white, and it preserves this property under orthogonal transformations. The decoding process in the next section will allow us to go from Z to single-shot data X. Notice that the product of any nonzero diagonal matrix with V is the solution of the general case in which the covariance of Z is required only to be diagonal, as defined in (1.26). Such a product allows us to solve the PCA problem.

The algorithmic steps of the whitening process are as follows:

(1) compute the covariance matrix of Y [i.e., C_{Y}⁽²⁾Y],
(2) apply the EVD of C_{Y}⁽²⁾,
(3) compute V as described in (1.28), and
(4) obtain the whitened data Z using (1.30).

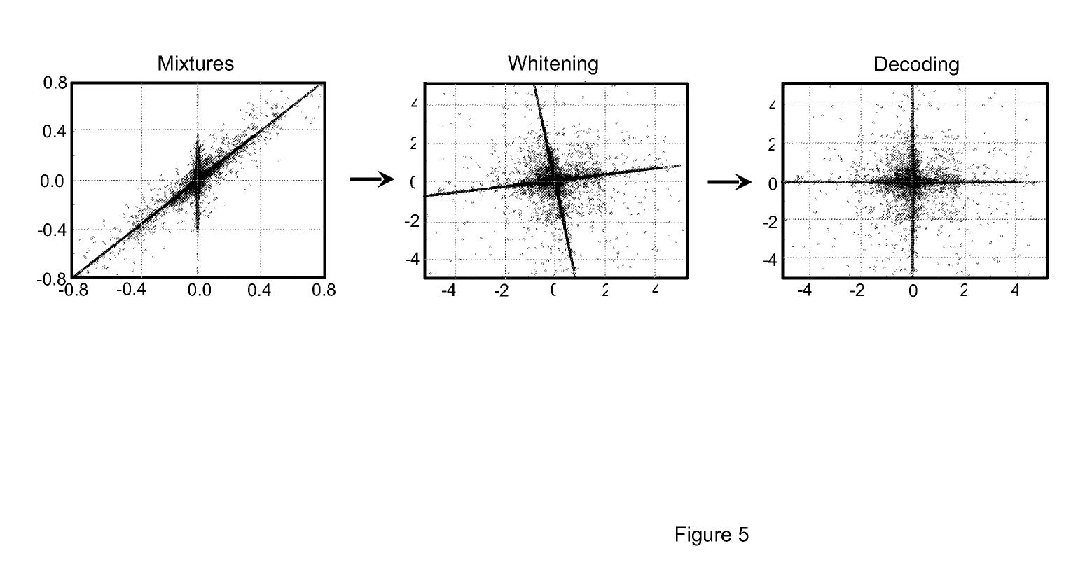

Let us look at some illustrations of the whitening process. FIG. 5 shows scatterplots of the results of whitening matrices of the multisweep-multishot data constructed by using a nonorthogonal matrix. We can see that the dominant axes of the whitened data are orthogonal; therefore the data Z₁ and Z₂ are uncorrelated. However, they are not independent, because these axes do not coincide with the vertical and horizontal axes of the 2D plot.

In summary, given the multisweep-multishot data Y, the whitening process aims at finding an orthogonal matrix, V, which gives us a new uncorrelated multisweep-multishot data, Z. It considers only the second-order statistical characteristics of the data. In other words, the whitening process uses only the joint Gaussian distribution to fit the data and finds an orthogonal transformation which makes the joint Gaussian distribution factorable, regardless of the true distribution of the data. In the next section, we describe some ICA decoding methods whose goals are to seek a linear transformation which makes the true joint distribution of the transformed data factorable, such that the outputs are mutually independent.

### 6.2 Algorithm #1

Our objective now is to decode whitened multisweep-multishot data; that is, we will go from whitened multisweep-multishot data to single-shot data. The mathematical expression of decoding is

$${X}_{i} = {\sum }_{i = 1}^{I} {w}_{ik} {Z}_{k} , \qquad ( 1.31 )$$

where Zₖ are the random variables describing the whitened multisweep-multishot data corresponding to the kth sweep and \hat{X}ᵢ are the random variables corresponding to the ith source point if the acquisition was performed conventionally, one source location after another. The matrix W={wᵢₖ} is an I×I matrix that we assume to be time- and receiver-independent.

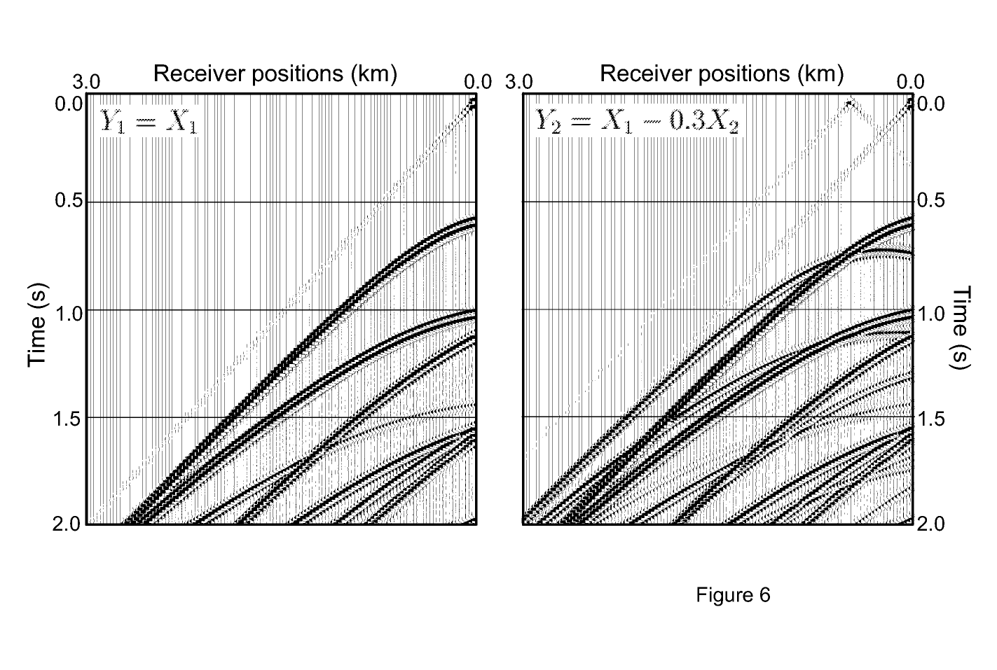

Note that if the set of random variables [X₁, . . . , X_{I}] forms a set of mutually independent random variables, then any permutation of [a₁X₁, . . . , a_{I}I_{I}], where aᵢ are constants, also forms a set of mutually independent random variables. In other words, we can shuffle random variables and/or rescale them in any way we like; they will remain mutually independent. Therefore the decoding process based on the statistical-independence criterion will reconstruct a scaled version of the original single-shot data, and not necessarily in a desirable order. However, the decoded shot gathers can easily be reorganized and resealed properly after the decoding process by using first arrivals or direct-wave arrivals. As we can see in FIG. 6, the first arrivals indicate the relative locations of sources with respect to the receiver positions. The direct wave, which is generally well separated from the rest of the data, can be used to estimate the relative scale between shot gathers. Therefore, the first arrivals and direct waves of the decoded data can be used to order and scale the decoded single-shot gathers.

Let us start by recalling the multilinearity property of fourth-order cumulants between two linearly related random vectors—that is,

$$\begin{matrix}Cum [ {Z}_{p} , {Z}_{q} , {Z}_{r} , {Z}_{s} ] = {\sum }_{i = 1}^{I} {\sum }_{j = 1}^{I} {\sum }_{k = 1}^{I} {\sum }_{l = 1}^{I} {\tilde{γ}}_{pi} {\tilde{γ}}_{qj} {\tilde{γ}}_{rk} {\tilde{γ}}_{sl} Cum [ {X}_{i} , {X}_{j} , {X}_{k} , {X}_{l} ] & ( 1.32 ) \\ or & \\ Cum [ {X}_{i} , {X}_{j} , {X}_{k} , {X}_{l} ] = {\sum }_{p = 1}^{I} {\sum }_{q = 1}^{I} {\sum }_{r = 1}^{I} {\sum }_{s = 1}^{I} {w}_{ip} {w}_{jq} {w}_{kr} {w}_{ls} Cum [ {Z}_{p} , {Z}_{q} , {Z}_{r} , {Z}_{s} ] , & ( 1.33 )\end{matrix}$$

where (1.32) is based on the coding relationship between Z and X in (??) and (1.33) is based on the decoding relationship between Z and X in (1.31). \tilde{γ}ₚᵢ are the elements of the coding matrix \tilde{Γ}, and wᵢₚ are the elements of the decoding matrix W. As the components of X are assumed to be independent, only the autocumulants in C_{Y}⁽⁴⁾ (i.e., Cum[Xᵢ, Xᵢ, Xᵢ, Xᵢ]) can be nonzero.

We can determine W by finding the orthonormal (or orthogonal) matrix which minimizes the sum of all the squared crosscumulants in C_{Y}⁽⁴⁾. Because the sum of the squared crosscumulants plus the sum of the squared autocumulants does not depend on W as long as W is kept orthonormal, this criterion is equivalent to maximizing

$$\begin{matrix}{ϒ}_{2 , 4} ( W ) = {\sum }_{i = 1}^{I} {( Cum [ {X}_{i} , {X}_{i} , {X}_{i} , {X}_{i} ] )}^{2} \\ = {\sum }_{i = 1}^{I} {( {\sum }_{p = 1}^{I} {\sum }_{q = 1}^{I} {\sum }_{r = 1}^{I} {\sum }_{s = 1`}^{I} {w}_{ip} {w}_{iq} {w}_{ir} {w}_{is} Cum [ {Z}_{p} , {Z}_{q} , {Z}_{r} , {Z}_{s} ] )}^{2} .\end{matrix} \qquad ( 1.34 )$$

The function [symbol] _{2,4}(W) is indeed a contrast function. Its maxima are invariant to the permutation and scaling of the random variables of X or Z. This property results from the supersymmetry of the cumulant tensors and the property in (??). The subscript 4 of [symbol] _{2,4}(W) indicates that we are diagonalizing a tensor of rank four, and the subscript 2 indicates that we are taking the squared autocumulants. For the general case, the contrast function denoted [symbol] _{ν,r} corresponds to the diagonalization of a cumulant tensor of rank r using the sum of the autocumulants at power ν; i.e.,

$${ϒ}_{v , r} = {\sum }_{i = 1}^{I} {\vert Cum \underbrace{[ {X}_{i} , {X}_{i} , … , {X}_{i} ]}_{r times} \vert}^{v} , \qquad ( 1.35 )$$

with ν≧1$ and r>2. Experience suggests that no significant advantage is gained by considering the cases in which ν≠2; that is why our derivation is limited to ν=2. Moreover, an analytic solution for W is sometimes possible when ν=2.

To further analyze the contrast function [symbol] _{2,4}(W), let us consider the particular case in which I=2. The decoding matrix for this case can be expressed as follows:

$$W = [ \begin{matrix}cos θ & sin θ \\ - sin θ & cos θ\end{matrix} ] . \qquad ( 1.36 )$$

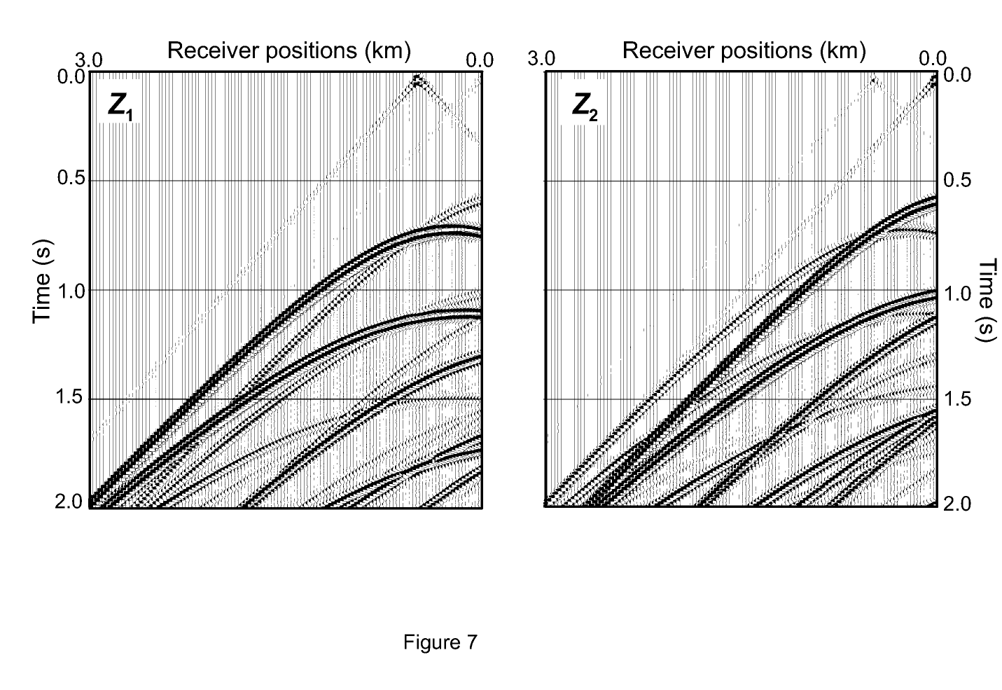

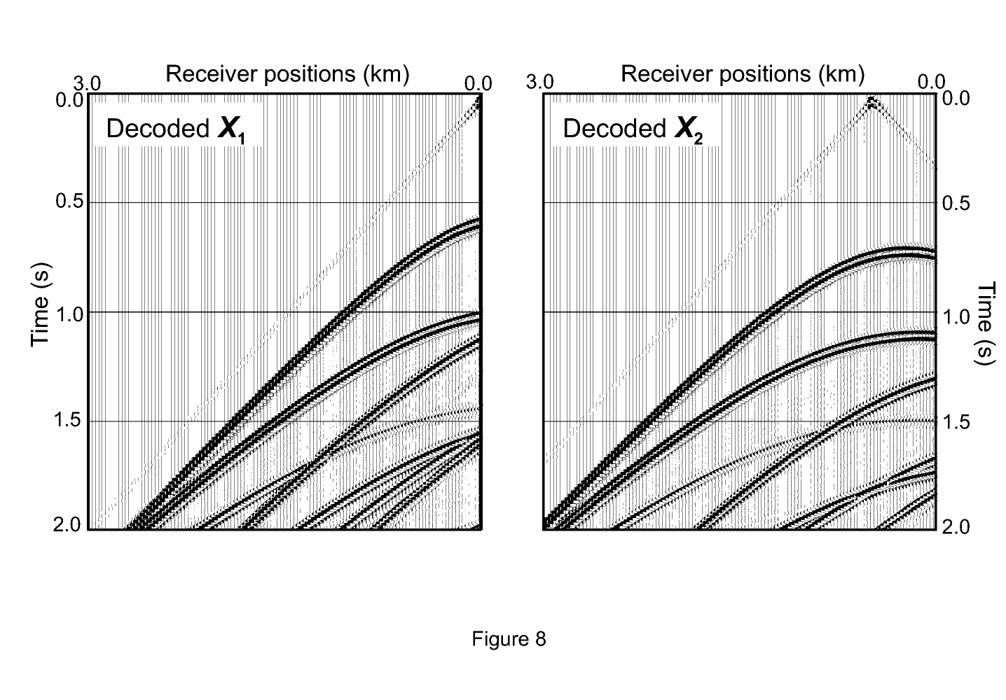

One can alternatively use W^{T}, which is also an orthonormal matrix, by replacing θ by −θ in (1.36). We can determine W by sweeping through all the angles from −π/2 to π/2; we then arrive at θₘₐₓ, for which $\Upsilon_{—}{2, 4}(\theta)$ is maximum. The decoding process comes down to (1) estimating θ₄, (2) constructing the decoding matrix W in (1.36) for θ=−θ₄/4, and (3) deducing the decoded data as X=WZ. The scatterplots in FIG. 5 of decoded seismic data show that we have effectively recovered the single-shot data in all these cases. The seismic whitened data and decoded data in FIGS. 7 and 8 also show that this decoding process allows us to recover the original single-shot data.

For I≧2, we propose the following algorithm:

(1) Collect multisweep-multishot data in at least two mixtures using two shooting boats, for example, or any other acquisition devices.

(2) Arrange the entire multishot gather (or any other gather type) in random variables Yᵢ, with i varying from 1 to I.

(3) Whiten the data Y to produce Z.

(4) Initialize auxiliary variables W′=I and Z′=Z.

(5) Choose a pair of components i and j (randomly or in any given order).

(6) Compute θ₄^{(ij)} using the cumulants of Z′ and deduce θₘₐₓ^{(ij)}.

(7) If θₘₐₓ^{(ij)}>ε, construct W^{(ij)} and update W′←W^{(ij)}W′.

(8) Rotate the vector Z′: Z′←W^{(ij)}Z′.

(9) Go to step (5) unless all possible θₘₐₓ^{(ij)}≦ε, with ε<<1.

(10) Reorganize and rescale properly after the decoding process by using first arrivals or direct-wave arrivals.

The symbol ← means substitution. In the fifth step, for example, the matrix on the right-hand side is computed and then substituted in W′. This notation is a very convenient way to describe iterative algorithms, and it also conforms with programming languages. We will use this convention throughout the invention.

This algorithm is based on the fact that any I-dimensional rotation matrix W can be written as the product of I(I−1)/2 two-dimensional-plane rotation matrices of size I×I.

Let us illustrate this decoding algorithm for the case in which I=4. We have generated four single-shot gathers with 125-m spacing between two consecutive shot points. We then mixed these four shot gathers using the following matrix:

$$Γ = [ \begin{matrix}1 & 0.5 & 0.8 & 1.5 \\ 1 & - 0.7 & 0.9` & - 1.1 \\ 1 & - 0.2 & - 0.6 & - 0.8 \\ 1 & - 2.1 & - 0.9 & 0.8\end{matrix} ] \qquad ( 1.37 )$$

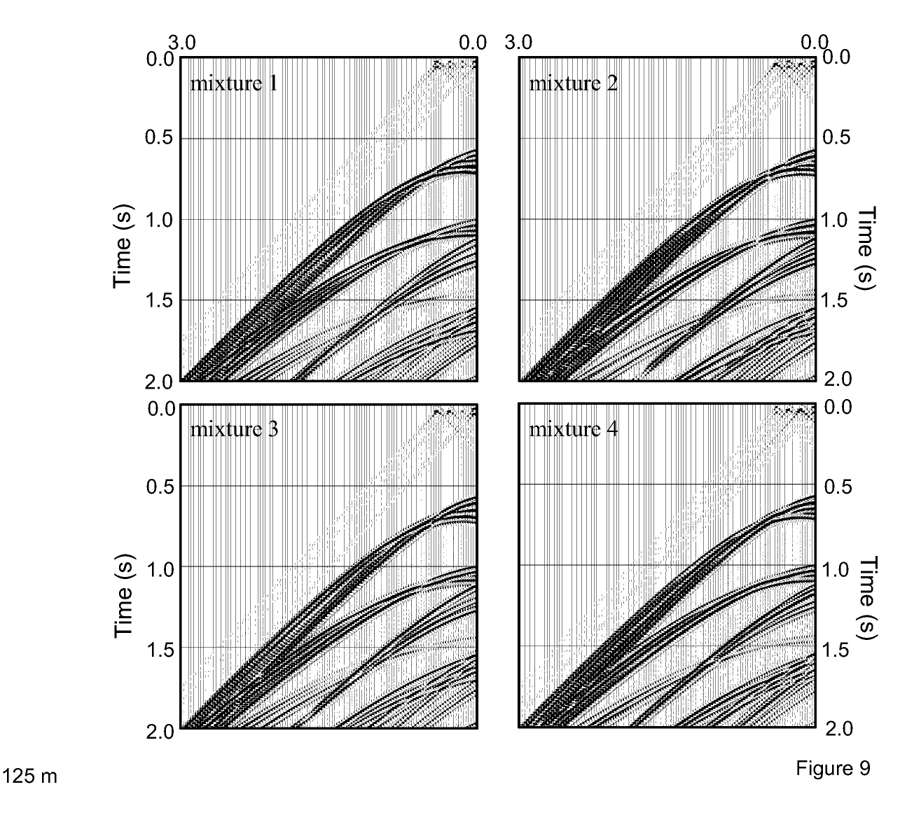

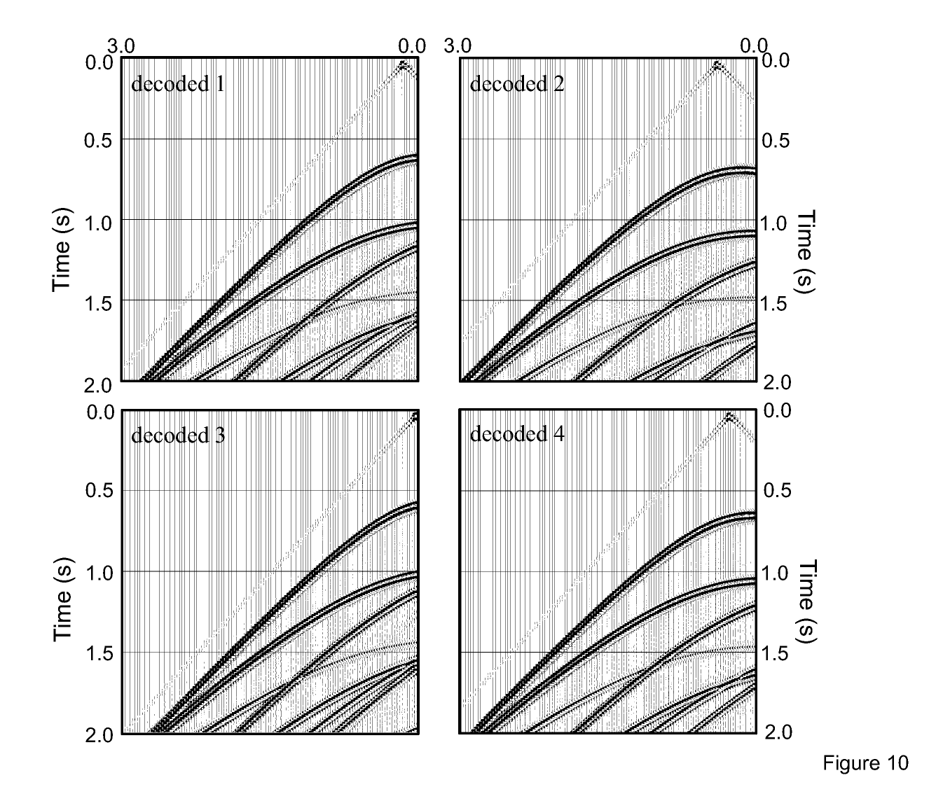

FIG. 9 shows the mixed data. We have then used the algorithm that we have just described to decode these mixed data. The results in FIG. 10 show that this algorithm is quite effective in decoding the mixed data.

### 6.3 Algorithm #2

Here is an alternative implementation:

(1) Collect multisweep-multishot data in at least two mixtures using two shooting boats, for example, or any other acquisition devices.

(2) Arrange the entire multishot gather (or any other gather type) in random variables Yᵢ, with i varying from 1 to I.

(3) Whiten the data Y to produce Z

(4) Compute the cumulant matrices Q^{(p,q)} of the whitened data vector Z.

(5) Initialize the auxiliary variables W′=I.

(6) Choose a pair of components i and j (randomly or in any given order).

(7) Compute θ₄^{(ij)} using Q^{(p,q)} and deduce

$${θ}_{max}^{( ij )} .$$

(8) If

$${θ}_{max}^{( ij )} > ɛ ,$$

construct W^{(ij)} and update W′←W^{(ij)}W′.

(9) Diagonalize the cumulant matrices: Q^{(p,q)}←W^{(i,j)}Q^{(p,q)}[W^{(i,j)}]^{T}.

(10) Go to step (5) unless all possible

$${θ}_{max}^{( ij )} \leq ɛ ,$$

with ε<<1.

(11) Reorganize and rescale properly after the decoding process by using first arrivals or direct-wave arrivals.

Notice that this algorithm is very similar to the algorithm described in the previous subsection. The only difference between the two algorithms, yet an important one, is that we here do not compute the cumulant tensor from the whitened data Z at each step. When the random variables of Z have large number samples, significant computational efficiency can be gained by using algorithm #1 instead of algorithm #2. Notice also that one can here use the EVD of one the cumulant matrices, say, Q(1,1), as a starting point of the decoding matrix instead of W=I.

### 6.4 Algorithm #3

We have also developed alternative implementations using the statistical concept of negentropy and the fact that seismic data are very sparse.

(1) Collect multisweep-multishot data in at least two mixtures using two shooting boats, for example, or any other acquisition devices.

(2) Arrange the entire multishot gather (or any other gather type) in random variables Yᵢ, with i varying from 1 to I.

(3) Whiten the data Y to produce Z.

(4) Choose I, the number of independent components, to estimate and set p=1.

(5) Initialize wₚ (e.g., a random-unit vector).

(6) Do an iteration of a one-unit algorithm on wₚ.

(7) Do the following orthogonalization:

$${w}_{p} = {w}_{p} - {\sum }_{j = 1}^{p - 1} ( {w}_{p}^{T} {w}_{j} ) {w}_{j} .$$

(8) Normalize wₚ by dividing it by its norm (e.g. wₚ←w/∥w∥).

(9) If wₚ has not converged, go back to step 6.

(10) Set p=p+1. If p is not greater than I, go back to step 5.

Here is the one-unit algorithm needed in algorithms #3.

(1) Choose an initial (e.g., random) vector w and an initial value of α.

(2) Update w←E└Zg(wᵢ^{T}Z)┘−E└g′(wᵢ^{T}Z)┘wᵢ.

(3) Normalize w←w/∥w∥.

(4) If not converged, go back to step 2.

### 6.5 Algorithm #4

Suppose that the multisweep-multishot data have been whitened and that there is a region of the data in which only one of the single-shot gathers contributes the multisweep-multishot gathers. In that region, the coding equation reduces to

$$\{ \begin{matrix}{Z}_{1} ( {t}_{A} , {x}_{A} ) = {\tilde{γ}}_{11} {X}_{1} ( {t}_{A} , {x}_{A} ) \\ {Z}_{2} ( {t}_{A} , {x}_{A} ) = {\tilde{γ}}_{21} {X}_{1} ( {t}_{A} , {x}_{A} )\end{matrix} , \qquad ( 1.38 )$$

where (t_{A},x_{A}) is one of the data points in that region. By using the fact that the decoding matrix for whitened data is orthogonal, like the one in (1.36), equation (1.39) can also be written as follows:

$$\{ \begin{matrix}{Z}_{1} ( {t}_{A} , {x}_{A} ) = cos ( {θ}_{max} ) {X}_{1} ( {t}_{A} , {x}_{A} ) \\ {Z}_{2} ( {t}_{A} , {x}_{A} ) = sin ( {θ}_{max} ) {X}_{1} ( {t}_{A} , {x}_{A} )\end{matrix} . \qquad ( 1.39 )$$

We can then obtain the specific value θₘₐₓ,

$$tan {θ}_{max} = \frac{{Z}_{2} ( {t}_{A} , {x}_{A} )}{{Z}_{1} ( {t}_{A} , {x}_{A} )} , \qquad ( 1.40 )$$

which is needed to compute the decoding matrix, W.

This idea can actually be generalized to recover both Γ, which can be inverted to obtain WV, thus avoiding the whitening process. Instead of trying to recover the following coding,

$$Γ = [ \begin{matrix}{γ}_{11} & {γ}_{12} \\ {γ}_{21} & {γ}_{22}\end{matrix} ] , \qquad ( 1.41 )$$

we will try the recover the matrix Γ′, which we define as follows:

$${Γ}^{′} = [ \begin{matrix}{γ}_{11} / {γ}_{21} & 1 \\ 1 & {γ}_{22} / {γ}_{12}\end{matrix} ] = [ \begin{matrix}{γ}_{11} & {γ}_{12} \\ {γ}_{21} & {γ}_{22}\end{matrix} ] [ \begin{matrix}1 / {γ}_{22} & 0 \\ 0 & 1 / {γ}_{12}\end{matrix} ] . \qquad ( 1.42 )$$

As the results of our decoding process are invariant with respect to the scale and permutations of the random variables, determining Γ or Γ′ has no effect on the results. So we decided to estimate Γ′. Notice that determining Γ′ comes down to determining only the diagonal of Γ′(i.e., γ₁₁/γ₁₂ and γ₂₂/γ₂₁).

(1) Collect multisweep-multishot data in at least two mixtures using two shooting boats, for example, or any other acquisition devices

(2) Arrange the entire multishot gather (or any other gather type) in random variables Yᵢ, with i varying from 1 to I.

(3) set the counter to k=1.

(4) Select a region of the data in which only single-shot Xᵢ contribute to the data.

(5) Compute the kth column of the mixing matrix using the ratios of mixtures.

(6) Set k=k+1. If k is not greater than I, go back to step 4.

(7) Invert the mixing matrix.

(8) Estimate the single-shot gathers as the product of the inverse matrix with the mixtures.

### 7 ALGORITHMS FOR CONVOLUTIVE MIXTURES

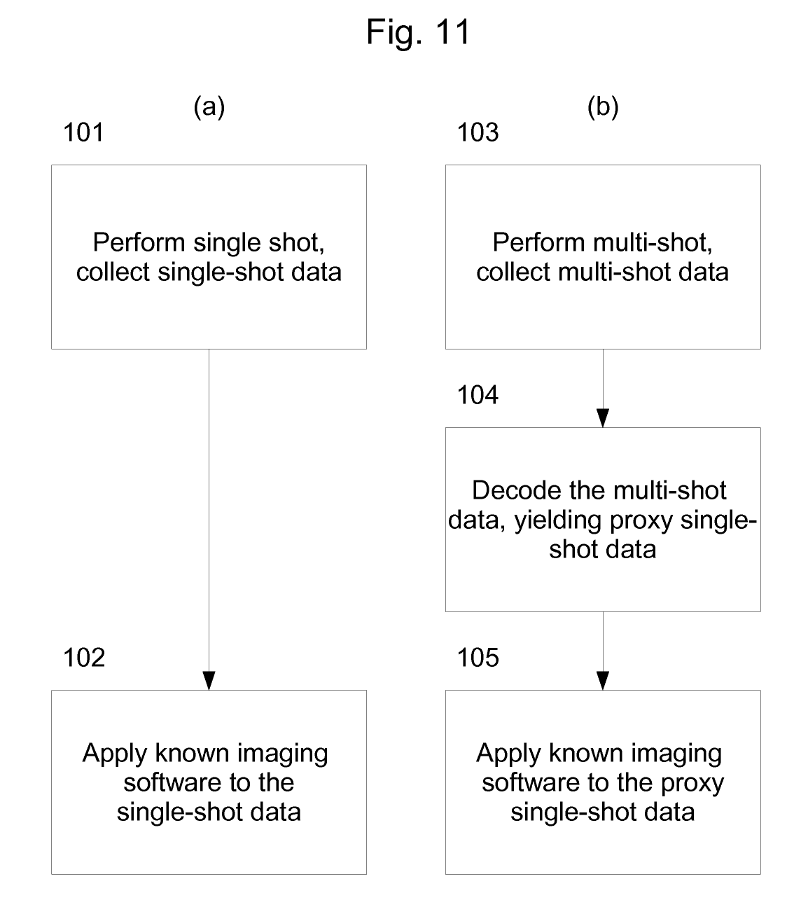

In the convolutive-mixture cases the coding of multisweep-multishot data can be expressed as follows:

$$\begin{matrix}{P}_{k} ( {x}_{r} , t ) = {\sum }_{i = 1}^{I} {A}_{ki} ( t ) * {H}_{i} ( {x}_{r} , t ) \\ = {\sum }_{i = 1}^{I} [ {\int }_{- ∞}^{∞} {A}_{ki} ( r ) {H}_{i} ( {x}_{r} , t - r ) d r ] ,\end{matrix} \qquad ( 1.43 )$$

where the star * denotes time convolution and where the subscript k, which describes the various sweeps, varies from 1 to I just like the subscript i does. So the multisweep-multishooting acquisition here consists of I shot points and I sweeps, with Pₖ(xᵣ,t) representing the k-th multishooting experiment; {P₁(xᵣ,t), P₂(xᵣ,t), . . . , P_{I}(xᵣ,t)} representing the multisweep-multishot data; Aₖᵢ(t) representing the source signature at the i-th shot point during the k-th sweep; and Hᵢ(xᵣ,t) representing the bandlimited impulse responses of the i-th single-shot data. FIG. 11 illustrates the construction of convolutive mixtures. Our objective in this section is to develop methods for recovering Hᵢ(xᵣ,t) and Aₖᵢ(t) from the multisweep-multishot data.

Our approach to the problem of decoding convolutive mixtures of seismic data is to reorganize (1.43) into a problem of decoding instantaneous mixtures. For example, by Fourier-transforming both sides of (1.43) with respect to time, the convolutive mixtures of seismic data can be expressed as a series of complex-valued instantaneous mixtures. In other words we can treat each frequency as a set of separate instantaneous mixtures which can be decoded by adapting the ICA-based decoding methods described earlier so that these methods can work with complex values. We will discuss these adaptations in this section.

In addition to reformulating the ICA-based decoding methods so that they can work with complex numbers, we will address the indeterminacies of these methods with respect to permutation and sign. As discussed earlier, the statistical-independence assumption on which the ICA decoding methods are based, is ubiquitous with respect the permutations and scales of the single-shot gathers forming the decoded-data vector. In other words, the first component of the decoded-data vector may actually be a₂H₂(x₂,t) (where a₂ is a constant), for example, rather than H₁(xᵣ,t). When the multisweep-multishot data are treated in the decoding process as a single random vector, then the decoded shot gathers can easily be rearranged into the desirable order and resealed properly by using first arrivals and direct-wave arrivals, as discussed earlier. However, when the decoding process involves several random vectors, as in the Fourier domain, where each frequency is associated with a random vector, an additional criterion is needed to align the frequency components of each decoded shot gather before performing the inverse Fourier transform. We will use the fact that seismic data are continuous in time and space to solve for these indeterminacies.

### 7.1 Convolutive Mixtures in the F-X Domain

Fourier-transform techniques are useful in dealing with convolutive mixtures because convolutions become products of Fourier transforms in the frequency domain. Thus we can apply the Fourier transform to both sides of Equation (1.43), to arrive a

$${P}_{k} ( {x}_{r} , ω ) = {\sum }_{i = 1}^{I} {A}_{ki} ( ω ) {H}_{i} ( {x}_{r} , ω ) \qquad ( 1.44 )$$

or alternatively at

$${H}_{i} ( {x}_{r} , ω ) = {\sum }_{k = 1}^{I} {B}_{ik} ( ω ) {P}_{k} ( {x}_{r} , ω ) , \qquad ( 1.45 )$$

where the functions Bᵢₖ(ω) represent the frequency response of the demixing system such that

$${\sum }_{k = 1}^{I} {A}_{ik} ( w ) {B}_{kj} ( w ) = {δ}_{ij} . \qquad ( 1.46 )$$

Notice that rather than using a new symbol to express this physical quantity after it has been Fourier-transformed, we have used the same symbol with different arguments, as the context unambiguously indicates the quantity currently under consideration. Again, this convention is used throughout the invention unless specified otherwise.

After the discretization of the frequency, (1.44) and (1.45) can be written as follows:

$$\begin{matrix}{Y}_{v , k} ( {x}_{r} ) = {\sum }_{i = 1}^{I} {\sum }_{j = 1}^{N} {α}_{v , ki} {X}_{v , i} ( {x}_{r} ) , & ( 1.47 ) \\ {X}_{v , i} ( {x}_{r} ) = {\sum }_{k = 1}^{I} {\sum }_{j = 1}^{N} {β}_{v , ik} {Y}_{v , k} ( {x}_{r} ) , \\ where & ( 1.48 ) \\ {Y}_{v , k} ( {x}_{r} ) = {P}_{k} [ {x}_{r} , ω = ( v - 1 ) Δ ω ] & ( 1.49 ) \\ {X}_{v , i} ( {x}_{r} ) = {H}_{i} [ {x}_{r} , ω = ( v - 1 ) Δ ω ) & ( 1.50 ) \\ {α}_{v , ki} = {A}_{ki} [ ω = ( v - 1 ) Δ ω ] , & ( 1.51 ) \\ {β}_{v , ik} = {B}_{ik} [ ω = ( v - 1 ) Δ ω ] , & ( 1.52 )\end{matrix}$$

and where Δω is the sampling interval in ω. The Greek index ν, which represents the frequency ω=(ν−1)Δω, varies from 1 to N, N being the maximal number of frequencies. Because the mixing elements are independent of receiver positions in seismic acquisition, we treat Y_{ν,k}(xᵣ) and X_{ν,i}(xᵣ) as random variables, with the receiver positions representing samples of these random variables. So the gathers Y_{ν,k}(xᵣ) and X_{ν,i}(xᵣ) will now be represented as Y_{ν,k} and X_{ν,i}, respectively; that is, we will drop the receiver variables.

Notice that the number of receivers describes our statistical samples in this case. The obvious question that follows from this remark is: is the number of receivers is statistically large enough to treat Y_{ν,k} and X_{ν,i} as random variables? The answer is yes. The number of receivers for a typical streamer today is 800. For the typical case in which the acquisition consists of eight streamers, we will end with about 3600 receivers per shot gather, which is large enough to consider Y_{ν,k} and X_{ν,i} as statistically well sampled.

Notice also that we can rewrite (1.47) and (1.48) as follows:

Y_{ν}=A_{ν}X_{ν} or X_{ν}=B_{ν}Y_{ν}, (1.53)

where

Y_{ν}=[Y_{ν,1}, . . . ,Y_{ν,I}]^{T} and X_{ν}=[X_{ν,1}, . . . ,X_{ν,I}]^{T} (1.54)

and where A_{ν} and B_{ν} are the complex matrices for the frequency ω=(ν−1)Δω, whose coefficients are α_{ν,ki} and β_{ν,ik}, respectively. We can see that the convolutive mixtures in (1.53) now becomes a series of instantaneous mixtures. That is, for each ν (i.e., for one frequency at a time), we can use the ICA-based decoding algorithms to recover X_{ν}. Therefore any of the algorithms described in the previous section can be used to decode as long as it is reformulated to work with complex-valued random variables, because Y_{ν} and X_{ν} are complex-valued vectors and A_{ν} and B_{ν} are complex matrices.

### 7.2 Whiteness of Complex-Valued Random Variables

As described in the previous sections, ICA-based decoding algorithms require that data be whitened (orthoganlized) before decoding them. The whitening process consists of transforming the original mixtures, say Y_{ν} (which is the ν-frequency slice of the original data in the F-X domain), to a new mixture vector, Z_{ν} (which is the whitened ν-frequency slice), such that its random variables are uncorrelated and have unit variance. Mathematically, we can describe this process as finding a whitening matrix V_{ν} that allows us to transform the random data vector Y_{ν} to another random vector, Z_{ν}=[Z_{ν,1}, Z_{ν,2}, . . . , Z_{ν,I}]^{T}, corresponding to the $\nu$-frequency slice of the whitened data; i.e.,

$${Z}_{v , i} = {\sum }_{k = 1}^{I} {v}_{v , ik} {Y}_{v , k} , \qquad ( 1.55 )$$

where V_{ν}={ν_{ν,ik}} is an I×I complex-valued matrix. Based on the whitening condition and on the linearity property of covariance matrices, we can express the covariance of Z as a function of V and of the covariance of Y:

C_{Z}_{_{ν}}⁽²⁾=E[Z_{ν}Z_{ν}^{H}]=E[V_{ν}Y_{ν}Y_{ν}^{H}V_{ν}^{H}]=V_{ν}C_{Y}⁽²⁾V_{ν}^{H}=I, (1.56)

and deduce that

V_{ν}=[C_{Y}⁽²⁾]^{-1/2}, (1.57)

The ν-frequency slice of whitened multisweep-multishot data is then obtained as

Z_{ν}=V_{ν}Y_{ν}. (1.58)

So the random vector Z_{ν} is said to be white, and it preserves this property under unitary transformations. In other words, if W_{ν} is a unitary matrix and X_{ν} is a random vector which is related to Z_{ν} by the unitary matrix W_{ν}, then X_{ν}=W_{ν}Z_{ν} is also white. However, the joint cumulants of an order greater than 2, like the fourth-order statistics of X_{ν} can be different from those of Z_{ν}. Actually, the ICA decoding that we will describe in next exploit these differences to decode data.

### 7.3 Statistical Independence Criteria with Constraints

Our objective now is to decode whitened data—that is to find a unitary matrix W which allows us to go from whitened frequency slices Z_{ν} to frequency slices of single-shot data. The mathematical expression of decoding is

$${X}_{v , i} = {\sum }_{i = 1}^{I} {ω}_{v , ik} {Z}_{v , k} , \qquad ( 1.59 )$$

where Z_{ν,k} are the complex random variables describing the whitened frequency slices of multisweep-multishot data and X_{ν,i} are the complex random variables corresponding to the frequency slices of single-shot data. The complex matrix W_{ν}={w_{ν,ik}} is an I×I matrix that we assume to be receiver-independent. We have described solutions of a similar problem in the previous sections for real random variables based on the criteria that the random variables of X_{ν} are mutually independent.

One of the key challenges in adapting these algorithms to complex random variables in general, and in particular in the frequency domain, is solving the problem independently for each frequency. In fact, if (W_{ν}, X_{ν}) is a solution of (1.59), then (W_{ν}ΛD, D^{H}Λ⁻¹X_{ν}) is also a solution of (1.59), where D is an arbitrary permutation matrix and Λ is an arbitrary diagonal matrix. This indetermination is a direct consequence of the nonuniqueness of the statistical independence criteria with respect to permutation and scale. In other words, if the random variables {X_{ν,1}, . . . , X_{ν,I}} are mutually independent, then any permutations of {a₁X_{ν,1}, . . . , a₁X_{ν,I}}, where aᵢ are constants, are also mutually independent random variables. These indeterminancies are easily solve in the X−T domain because a single decoding matrix is estimated for all the data. In the frequency domain, permutation and even sign indeterminancies may vary between two frequencies, and yet we have the ordering of the decoded frequency slices, which must remain the same along the frequency axis in order to Fourier transform the data back to the time domain. That is why the inderterminancy problem is a challenge in this case.

Let us denote by B_{ν} the demixing matrix; i.e., B_{ν}=W_{ν}V_{ν}, with X_{ν}=B_{ν}Y_{ν}. The scaling problem associated with ICA-decoding can be addressed by using the following scaling matrix

\hat{B}_{ν}=Diag(B_{ν}⁻¹)B_{ν} (1.60)

instead of B_{ν}. The expression Diag(B_{ν}⁻¹) in this equation means the diagonal matrix are made of the diagonal elements of B_{ν}⁻¹. The independent components obtained using \hat{B}_{ν} are \hat{X}_{ν}=\hat{B}_{ν}Y_{ν}. As \hat{X}_{ν} and \hat{X}′_{ν} differs by just the diagonal Diag(B_{ν}⁻¹), they are both valid solutions to our decoding under the statistical-independent criterion. However, the good news is that \hat{B}_{ν} is scaled independent because we can multiply \hat{B}_{ν} by any arbitrary diagonal matrix D without changing \hat{B}_{ν}. More precisely, we can verify that

Diag(D⁻¹B_{ν}⁻¹)DB_{ν}=Diag(B_{ν}⁻¹)B_{ν}=\hat{B}_{ν}. (1.61)

Therefore, by using \hat{B}_{ν} instead of B_{ν} for the demixing matrix, we ensure that the scaling of our solution is consistent throughout the frequency spectrum.

Let us now turn to the indeterminancy associated with the permutations of ICA-decoding solutions. One way of addressing this challenge is to introduce additional constraints to the statistical-independence criteria. Possible constraints can be proposed based on the fact that seismic data are continuous in space as well as in frequency. Therefore, the decoded data X_{ν} at frequency ν can be compared to the decoded data X_{ν+1} at frequency ν−1. This comparison can be done by calculating the distance between any possible permutations of X_{ν} and X_{ν-1}. The permutation which yields the smallest distance is assumed to be the correct permutation. Notice that, for an I dimension vector X_{ν}, there are I! permutations. Therefore this method becomes slow for large I. Alternatively, one can use the fact that the source signatures—that is, the components of \hat{B}_{ν}⁻¹ are continuous to constraint the statistical-independence criteria. Again, the permutation which yields the smallest distance is assumed to be the correct permutation.

### 7.4 Algorithm #5

Our objective here is to describe one possible way of estimating the unitary ICA matrix W_{ν} for a given whitened frequency slice Z_{ν}. We will first illustrate our solution for the particular case of two mixtures (i.e., I=2) before describing it algorithmically for arbitrary value of I.

When I=2, the ICA matrix can be expressed as follows:

$${W}_{v} = [ \begin{matrix}cos {θ}_{v} & exp [ i {φ}_{v} ] sin {θ}_{v} \\ - exp [ - i {φ}_{v} ] sin {θ}_{v} & cos {θ}_{v}\end{matrix} ] . \qquad ( 1.62 )$$

We can easily verify that this matrix is unitary. One can alternatively use W_{ν}^{H}; i.e.,

$${W}_{v}^{H} = [ \begin{matrix}cos {θ}_{v} & - exp [ i {φ}_{v} ] sin {θ}_{v} \\ exp [ - i {φ}_{v} ] sin {θ}_{v} & cos {θ}_{v}\end{matrix} ] , \qquad ( 1.63 )$$

which is also an unitary matrix. Our approach to determining W_{ν} is based on (i) the multilinear relationship between the fourth-order joint cumulants of Z_{ν} and on (ii) the assumption that the random variables of X_{ν} are statistically independent. The multilinear relationship between the fourth-order joint cumulants of Z_{ν} and those of X_{ν}, under the assumption that the random variables of X_{ν} are statistically independent, can be written as follows:

$$Cum [ {Z}_{v , i} , {Z}_{v , j} , {\tilde{Z}}_{v , k} , {\tilde{Z}}_{v , l} ] = {\sum }_{p = 1}^{I} {ω}_{v , ip}^{H} {ω}_{v , jp}^{H} {\tilde{ω}}_{v , kp}^{H} {\tilde{ω}}_{v , lp}^{H} Cum [ {X}_{vp} , {X}_{v , p} , {\tilde{X}}_{v , p} , {\tilde{X}}_{v , p} ] , \qquad ( 1.64 )$$

where w_{ν,ip}^{H} are the elements of matrix W^{H}. After substitution, we obtain the following system of six equations for four unknowns:

$$\{ \begin{matrix}{c}_{11}^{11} = {κ}_{1} {cos}^{4} {θ}_{v} + {κ}_{2} {sin}^{4} θ \\ {c}_{22}^{22} = {κ}_{1} {sin}^{4} {θ}_{v} + {κ}_{2} {cos}^{4} θ \\ {c}_{11}^{22} = ( {κ}_{1} + {κ}_{2} ) exp [ i 2 {φ}_{v} ] {cos}^{2} {θ}_{v} {sin}^{2} {θ}_{v} \\ {c}_{12}^{12} = ( {κ}_{1} + {κ}_{2} ) {cos}^{2} {θ}_{v} {sin}^{2} {θ}_{v} \\ {c}_{11}^{12} = exp [ i {φ}_{v} ] ( {κ}_{1} {cos}^{3} {θ}_{v} sin {θ}_{v} - {κ}_{2} {sin}^{3} {θ}_{v} cos {θ}_{v} ) \\ {c}_{12}^{22} = exp [ i {φ}_{v} ] ( {κ}_{1} cos {θ}_{v} {sin}^{3} {θ}_{v} - {κ}_{2} sin {θ}_{v} {cos}^{3} {θ}_{v} ) ,\end{matrix} \qquad ( 1.65 )$$

where θ, φ, κ₁ and κ₂, are the unknowns. We have used the following abbreviated notations for the elements of the fourth-order cumulant tensors of Z_{ν} and X_{ν}: cᵢⱼ^{ki}=Cum[Z_{ν,i},Z_{ν,j}, Z̅_{ν,k}, Z̅_{ν,l}] and κᵢ=Cum[X_{ν,i},X_{ν,i}, X̅_{ν,i}, X̅_{ν,i}].

So the complex ICA decoding process comes down to (1) estimating θ_{ν} and φ_{ν}, (2) constructing the decoding matrices W_{ν} and B̅_{ν}, and (3) deducing the decoded data as X_{ν}=\hat{B}_{ν}Z. After these computations have been performed for all the frequency slices of the data, a rearrangement of the frequency slices, using the fact that seismic data are continuous or that the seismic source signatures are continuous in the frequency domain, is needed.

Here are the steps of our algorithm:

(1) Collect multisweep-multishot data in at least two mixtures using two shooting boats, for example, or any other acquisition devices.

(2) Take the Fourier transform of the data with respect to time.

(3) Choose a frequency slice of data, Y_{ν}.

(4) Whiten the frequency slice to produce Z_{ν} and V_{ν}.

(5) Apply a complex ICA to Z_{ν} and produce W_{ν}.

(6) compute B_{ν}=W_{ν}V_{ν} and deduce \hat{B}_{ν}=Diag(B_{ν}⁻¹)B_{ν}.

(7) Get the independent components for this frequency slice: \hat{X}_{ν}=\hat{B}_{ν}Y_{ν}.

(8) Go to (2) unless all frequency slices have been processed.

(9) Use the fact that seismic data are continuous in frequency to produce permutations of the random variables of \hat{X}_{ν} which are consistent for all frequency slices.

(10) Take the inverse Fourier-transform of the permuted frequency slices with respect to frequency.

### 8 ALGORITHMS FOR UNDERDETERMINED MIXTURES

In previous algorithms, we have assumed in our decoding process that the number of mixtures (i.e., K) equals the number of single-shot gathers (i.e., I); that is, K=I. In this section, we address the decoding process for the cases in which the number of mixtures is smaller than the number of single-shot gathers; that is, K<I.

One important characteristic of seismic data is that they are sparse. To reemphasize this point, we consider the two mixtures (i.e., K=2). Each mixture is a composite of four single-shot gathers (i.e., I=4). From the scatterplot of these two mixtures, we will see four directions of concentration of the data points. These data concentrations on particular directions indicate the sparsity of our data. Each of these directions corresponding to one of the four single-shot gathers is contained in the mixtures. Therefore if we can filter the data corresponding to two of these four directions of data concentrations, we will return to the classical formulation of decoding described with K=I that we now know how to solve. Alternatively, we can impose additional constraints so that our decoding problem can become well-posed. These additional constraints can be based on the fact our data are sparse. The first part of this section describes decoding methods based essentially on the sparsity of seismic data.

Suppose now that our seismic data are contaminated by uniform distribution. It is no longer possible to take advantage of sparsity for our decoding. Fortunately, there is significant a priori knowledge about the seismic acquisition that we can use to construct additional synthetic mixtures from the recorded mixtures. The additional mixtures allow us again to turn from the underdetermined decoding problem to a well-posed problem that we can solve by using the independent component analysis (ICA) described in Chapters 2 and 3. We call these additional mixtures virtual mixtures because they are not directly recorded during seismic-acquisition experiments.

More than 90 percent of seismic data acquired today are still based on towed-streamer-acquisition geometry. In this geometry, the boat carries the source and receivers, and it is obviously in constant motion. For this reason, we will often end up with single-mixture datasets, that is, with K=1 and I as large as 8 or more. Again, we are fortunate that there is significant a priori knowledge about the acquisition that can be used to construct virtual mixtures from single mixtures, thus overcoming the mixture underdeterminancy.

### 8.1 Algorithm #6

As we did in previous sections, we assume here that we have K multishot gathers described by a random vector Y=[Y₁, Y₂, . . . , Y_{K}]^{T}, where each random variable of Y is a mixtures of I single-shot gathers. If the single-shot gathers are also grouped into a random vector X=[X₁, X₂, . . . , X_{I}]^{T}, then we can relate the multishot data to single-shot data as follows

Y=AX, (1.66)

where A is a K×I matrix known as the mixing matrix. In the previous sections, we describe solutions to the reconstruction of X from a given vector of mixtures Y for the particular case in which K=I. Our objective in this section is to derive solutions for recovering X from Y for the more common cases in which K<I (i.e., the number of mixtures is smaller than the number of single-shot gathers).

In solving the underdetermined decoding problem (i.e., K<I), the estimation of A does not suffice to determine the single-shot gathers because we have more degrees of freedom than constraints. So it is customary to consider a two-step process for recovering single-shot gathers: (i) the estimation of the mixing matrix, A, and (ii) the inversion of A to obtain the single-shot gather vector X. This is the approach we will follow in this section. The cornerstone for estimating the mixing matrix and its inverse in this section is the notion of sparsity.

Even when the mixing matrix A is known, since the system in Eq. (1.66) is underdetermined, its solution is not unique. One approach consists of dividing the scatterplot into frames in which only one single-shot gather is active. Thus the scatterplot has four frames that we are interested in for the extraction of single-shot gathers. In the geometrical approach to the extraction of single-shot gathers, each of these frame is regarded as a representation of the single-shot gathers. By selecting an area where only two single-shot gathers are active, say X₁ and X₂, and zero-padding the scatterplot outside this area, we produce a deterministic system like this one:

$$( \begin{matrix}{Y}_{1} \\ {Y}_{2}\end{matrix} ) = ( \begin{matrix}cos {θ}_{1} & cos {θ}_{2} \\ sin {θ}_{1} & sin {θ}_{2}\end{matrix} ) ( \begin{matrix}{X}_{1} \\ {X}_{2}\end{matrix} ) , \qquad ( 1.67 )$$

from which we can recover X₁ and X₂. Unfortunately, this approach sometimes produces poor results because there are often significant numbers of active points are outside our defined frame. Actually, the results are sometime quite rough.

One way of improving the geometric extraction of single-shot gathers is to use sparse matrices in addition to sparse data—for example, the following mixing matrix:

$$A = ( \begin{matrix}1 & 0 & 1 & - 1 \\ 1 & 1 & 0 & 1\end{matrix} ) . \qquad ( 1.68 )$$

One may wonder how to produce simultaneously negative and positive polarized seismic sources which will lead to this mixing matrix. In vibroseis source, this is easily achieved because we have direct control of the phase of the vibroseis source. However, it is a much more difficult proposition in marine acquisition. In any case, at least the following 2×3 matrix

$$A = ( \begin{matrix}1 & 0 & 1 \\ 1 & 1 & 0\end{matrix} ) , \qquad ( 1.69 )$$

corresponding to two mixtures and three single-shot gathers can be used. Notice that in this case only two are active at any given sample of the mixtures.

Another way of improving the effectiveness of geometrical extraction is to transform mixtures in the F-X or T-F-X domain and perform the extraction in these domains. The transformation from the T-X domain to the F-X domain is done by taking the Fourier transforms of the mixtures with respect to time. The transformation from T-X domain to T-F-X domain is done by the taking the window-Fourier transforms of the mixtures with respect to time. One can alternatively use wavelet transform, deVille, or any other time-frequency transform (see Ikelle and Amundsen, 2005). The data concentration is much more effective in these domains, so their extraction is much more effective.

### 8.2 Extraction of Single-Shot Gathers: the L1-Norm Approach

Another way of taking advantage of sparsity in the extraction of single-shot data X from mixtures Y is to use the L_{q}-norm optimization, where q≦1, through a short path search, as suggested by Boffil et al. (200xx) or through linear programming techniques (Press et al., 198x).

### Short-Path Implementation

The basic idea in the short-path implementation is to find X that minimizes the L1-norm, as in Eq. (6). In this case, the optimal representation of the data point,

$${Y}^{t} = {\sum }_{j} {a}^{j} {X}_{j}^{t} , \qquad ( 1.70 )$$

that minimizes

$${\sum }_{j} \vert {X}_{j}^{t} \vert$$

is the solution of the corresponding linear programming problem. Geometrically, for a given feasible solution, each source component is a segment of length |Xⱼ| in the direction of the corresponding aⱼ, and by concatenation their sum defines a path from the origin to Y^{t}. Minimizing

$${\sum }_{j} \vert {X}_{j}^{t} \vert$$

therefore amounts to finding the shortest path to Y^{t} over all feasible solutions. Notice that, with the exception of singularities, since a mixture space is M-dimensional, M (independent) basis vectors aⱼ will be required for a solution to be feasible (i.e., to reach xt without error).

For the two-dimensional case (see FIG. 2), the shortest path is obtained by choosing the basis vectors a^{b} and a^{a}, whose angles tan⁻¹(a₂^{b}/a₁^{b}) and tan⁻¹(a₂^{a}/a₁^{a}) are closest, from below and from above, respectively, to the angle θₜ of Y^{t}.

Let Aᵣ=[a^{b}a^{a}] be the reduced square matrix that includes only the selected basis vectors, and let Wᵣ=Aᵣ⁻¹ and let Xᵣ^{t} be the decomposition of the target point along a^{b} and a^{a}. The components of the sources are then obtained as

Xᵣ^{t}=WᵣY^{t} (1.71)

Xⱼ^{t}=0 for j≠b,a. (1.72)

In practice, when applied to all t=1, . . . , T, each reduced matrix Wᵣ only needs to be computed once for all data points between any two pairs of basis vectors.

### Linear Programming

An alternative method is to view the problem as a linear program [Chen et al, 1996]:

minc^{T}X subject to Y=AX. (1.73)

Letting c=[1, . . . , 1], the objective function in the linear program,

$${c}^{T} \vert X \vert = {\sum }_{i} \vert {X}_{i} \vert ,$$

corresponds to maximizing the log posterior likelihood under a Laplacian prior. This can be converted to a standard linear program (with only positive coefficients) by separating positive and negative coefficients. Making the substitutions, X←[u; v], c←[1; 1], and A←[A, −A], the above equation becomes

min1^{T}[u;v] subject to Y=[A,−A][u;v], u,v≧0, (1.74)

which replaces the basis vector matrix A with one that contains both positive and negative copies of the vectors. This separates the positive and negative coefficients of the solution X into the positive variables u and v, respectively. This can be solved efficiently and exactly with interior point linear programming methods (Chen et al, 1996). Quadratic-programming approaches to this type of problem have also recently been suggested (Osuna et al., 1997).

We have used both the linear-programming and short-path methods. The linear-programming methods were superior for finding exact solutions in the case of zero noise. The standard implementation handles only the noiseless case but can be generalized (Chen et al., 1986). We found short-path methods to be faster in obtaining good approximate solutions. They also have the advantage that they can easily be adapted to more general models, e.g., positive noise levels or different apriors.

### Flowchart

In summary, the algorithm for decoding underdetermined mixtures can be cast as follows:

(1.) Collect at least two mixtures using either two boats or two source arrays.

(2.) Estimate the mixing matrix using either histogram approach, probably density approach, the cumulant optimization criterion.

(3.) Extract data using either the geometrical approach, the L1-norm optimization or short-path approach.

### 8.3 Algorithm #7

In this section and the rest of the invention, we assume that only a single mixture of the data is available (i.e., K=1 and I>1). Thus we cannot use the sparsity-based method described in the previous section. The approach that we will now follow consists of constructing new additional mixtures that we call virtual mixtures. The construction of virtual mixtures is primarily based on our a priori knowledge of multishooting acquisition geometries. It is also based on processing schemes which allow us to exploit this a priori knowledge to construct virtual mixtures. In this section, we describes how adaptive filtering and sources encoded in a form similar to TDMA (i.e., contiguous timeslots of about 100 ms are located at each source) can be used to create virtual mixtures.

The decoding method that we have just described does not apply to sources with short duration like the one encountered in marine acquisition because these sources are stationary. We here propose an alternative method based on the time delays of the source signatures. So we now define the multishoot as follows:

$$\begin{matrix}P ( {x}_{r} , t ) = {\sum }_{i = 1}^{I} {P}_{i} ( {x}_{r} , t ) = {\sum }_{i = 1}^{I} a ( t - {r}_{i} ) * {H}_{i} ( {x}_{r} , t ) , \\ with & ( 1.75 ) \\ {P}_{i} ( {x}_{r} , t ) = a ( t - {r}_{i} ) * {H}_{i} ( {x}_{r} , t ) , & ( 1.76 )\end{matrix}$$

where a(t) is the stationary marine-type source signatures like the one described in FIG. 2.xx and Hᵢ(xᵣ,t) are the bandlimited impulse responses associated with the i-th shot point of the multishot array. We do not assume that the source signatures a(t) are unknown. However, we assume that τᵢ are known. The amplitude spectra of the sources can be identical or different; this choice has no bearing on the decoding. However, the delays between the source signatures must be a priori knowledge. To facilitate our discussion, we will express as a function the single-shot gather as follows:

τᵢ=(i−1)*Δτ, (1.77)

where Δτ is the time delay between consecutive shot points in the multishooting array. Δτ must be significant to ensure that the statistic decoding as the ones describe in the previous sections can be used in the decoding P(xᵣ,t). For a multishot gather of 1000 traces, it is desirable to have Δτ with 50 samples or more to form a total of 50,000 samples, which is sufficient for ICA processing. We will see later how this number is computed. Another key assumption here is that the shot gathers are so closely spaced, say, 25 m or less, so that an adaptive filtering technique can be used between two consecutive single-shot gathers.

The basic idea is that we can create shot gathers with significant time delays between them and perform a decoding sequentially, one window of data at a time. Let us start with the first window. We will denote the data in this window by Q₁(xᵣ,t) and the contribution of the k-th single-shot gather to Q₁(xᵣ,t) by K_{1,k}(xᵣ,t), where the first index describes the window under consideration and the second index described the single-shot gather. For the case of a multishot gather composed of four single-shot gathers, we will have

Q₁(xᵣ,t)=K_{1,1}(xᵣ,t)+K_{1,2}(xᵣ,t)+K_{1,3}(xᵣ,t)+K_{1,4}(xᵣ,t). (1.78)

We select the first window such that only the first single shot Pᵢ(xᵣ,t) contributes to Q₁(xᵣ,t). In other words, K_{1,2}(xᵣ,t)=K_{1,3}(xᵣ,t)=K_{1,4}(xᵣ,t)=0 in this window; therefore no decoding is needed here. However, we have to properly define the boundaries of this window to ensure that Q₁(xᵣ,t)=K_{1,1}(xᵣ,t). The interval [0, t₁(xᵣ)] defines this window with t₁(xᵣ)=t₀(xᵣ)+Δτ where t₀(xᵣ) is the first break. Thus the estimation of the first boundary of the first comes down to estimating the first breaks.

Let us now move to the second window corresponding to interval [t₁(xᵣ), t₂(xᵣ)] of the data, with t₂(xᵣ)=t₁(xᵣ)+Δτ. We will denote the data in this window by Q₂(xᵣ,t) and the contribution of the k-th single-shot gather to Q₂(xᵣ,t) by K_{2,k}(xᵣ,t), where the first index describes the window under consideration and the second index describes the single-shot gather. For the case of a multishot gather composed of four single-shot gathers, we will have

Q₂(xᵣ,t)=K_{2,1}(xᵣ,t)+K_{2,2}(xᵣ,t)+K_{2,3}(xᵣ,t)+K_{2,4}(xᵣ,t). (1.79)

K_{2,3}(xᵣ,t)=K_{2,3}(xᵣ,t)=0 in this window. Therefore the decoding is needed, but it involves only to the first two single-shot gathers. The decoding consists of shifting down in time K_{1,1} by Δτ and adapting it K_{2,2}(xᵣ,t). The adaptive technique is described in Haykin (1997) can be used for this purpose. We then create a new mixture with the delayed and adapted K_{1,1}, which we denote

Q₂^{t}(xᵣ,t)=m₂(x,t)*K_{1,1}(xᵣ,t+Δτ). (1.80)

where m₂(x,t) is the adaptive filter. We then use the classical ICA technique for the following system:

$$( \begin{matrix}{Q}_{k} \\ {Q}_{k}^{′}\end{matrix} ) = ( \begin{matrix}1 & 1 \\ α & 0\end{matrix} ) ( \begin{matrix}{K}_{k , 1} \\ {K}_{k , 2}\end{matrix} ) , \qquad ( 1.81 )$$

with (k=2). We determine K_{2,1}(xᵣ,t) which we subtract from Q₂(xᵣ,t) to obtain K_{2,2}(xᵣ,t).

(1) Collect single-mixture data P(xᵣ,t) with a multishooting array made of I identical stationary source signatures, which are fired with Δτ between two consecutive shots.

(2) Construct the data for the first window corresponding to the interval [0, t₁(xᵣ)] of the data P(xᵣ,t) with t₁(xᵣ)=t₀(xᵣ)+Δτ, where t₀(xᵣ) is the first break. We denote these data Q₁(xᵣ,t)=K_{1,1}(xᵣ,t). Only the first single-shot gather contributes to the data in this window: therefore no decoding is needed.

(3) Set the counter to i=2, where the index indicates the i-th window. The interval of this window is [t₂(xᵣ), t₃(xᵣ)], with t₃(xᵣ)=t₂(xᵣ)+Δτ.

(4) Construct the data corresponding to the i-th window. We denote these data by Qᵢ(xᵣ,t)=Σₖ₌₁^{I}K_{i,k}(xᵣ,t) where K_{i,k}(xᵣ,t) is the contribution of the k-th single shot gathers to the multishot data in this window Note that K_{i,k}(xᵣ,t) is zero if k>i.

(5) Shift and adapt K_{i-1,k-1} to K_{i,k}.

(6) Use the adapted K_{i-1,k-1} as mixtures in addition to Qᵢ(xᵣ,t), to decode Qᵢ(xᵣ,t) using the ICA technique.

(7) Reset the counter, i←i+1 and go to step (4) unless we have the last window of the data has just been processed.

### 8.4 Algorithm #8

We here describe an alternative way of decoding data generated by source signatures encoded in a TDMA fashion (i.e., contiguous timeslots of about 100 ms are allocated at each source signatures). Our decoding is based on the same principles as the previous one—that is,

(i) Known time delays can be introduced between the various shooting points via the source signature;

(ii) Two closely spaced shooting points produce almost identical responses. However, here we assume that at least one single-shot gather, which we will call a reference-shot gather, is also available.

The basic idea of our optimization to find a matching filter between the reference shot and the nearest single-shot gathers of the multishot gather. We can use, for example, the adaptive filters described in Haykin (1997).

If more than one single shot is used, we can also use to the reciprocity theorem to further constrain the optimization. In fact, based on the reciprocity theorem, we can recover N traces of each of single-shot gather if we have N reference shots.

(1) Collect a single mixture data with a multishooting array made of I identical stationary source signatures, which are fired at different times τᵢ(xₛ) and collect a reference single-shot gather.

(2) Adapt this single-shot gather to the nearest single-shot gather in the multishot gather.

(3) Use the adapted single-shot gathers as new mixtures in addition to the recorded mixture.

(4) Apply the ICA algorithms (1, 2, 3, or 4, for example) to decode one single-shot gather and to obtain a new mixtures with one single-shot gather.

(5) Unless the output of step (4) is two single-shot gathers, go back to (4) using the new mixture and the new single-shot gather as reference shot or with the original reference shot

### 8.5 Algorithm #9

Here we consider the entire seismic data instead of a single multishot gather as we have done earlier in this section. From these multishot gathers, we create common receiver gathers by re-sorting data, as described in the previous sections. We will focus first on the particular case in which the multishoot array is made of two shot points (i.e., I=2). We will later discuss the extension of the results to I>2.

The basic idea is to introduce of delay between the initial firing shot in the multishooting array in such a way that, when data are sorted into receiver gathers, the signal associated with a particular shot position in the multishot array will have apparent velocities different from the signals associated with the other shot points in the multishooting array. F-K filtering can then be used to separate one single-shot receiver gather from the other. Because of various potential imperfections in differentiating the data by F-K filtering, the separation results are used only as virtual mixtures. Then with ICA we can recover more accurately the actual data.

Alternatively, one can use τ−p filtering instead of F-K filtering. The time delay between shots most be designed in such a way that the events of one single-shot gather follow a particular shape (e.g., hyperbolic, parabolic, linear) while the other events of the other gathers follow totally different shapes.

(1) Collect single-mixture data with a multishooting array made of I identical stationary source signatures which are fired at different times τᵢ(xₛ). These firing times are chosen so that the apparent velocity spectra of single-shot gathers can be significantly different to allow us to separate the single-shot gathers by F-K dip filtering.

(2) Sort the data into receiver gathers.

(3) Transform the receiver gathers in the F-K domain.

(4) Apply F-K dip filtering to produce an approximate separation of the data into single-shot gathers.

(5) Inverse Fourier-transforms the separated single-shot gathers.

(6) Use these single-shot receivers gathers as new mixtures in addition to p(xₛ,t).

(7) Produce the final decoded data by using ICA techniques.

### 8.6 Algorithm #10

Consider the problem of decoding a single mixture constructed of nonstationary source signatures. Mathematically, this mixture can be expressed as follows:

$$\begin{matrix}P ( {x}_{r} , t ) = {\sum }_{i = 1}^{M} {a}_{i} ( t ) * {H}_{i} ( {x}_{r} , t ) \\ = {\sum }_{i = 1}^{M} [ {\int }_{- ∞}^{∞} {a}_{i} ( r ) {H}_{i} ( {x}_{r} , t - r ) d r ] ,\end{matrix} \qquad ( 1.82 )$$

where aᵢ(t) are the nonstationary vibroseis type source signatures and Hᵢ(xᵣ,t) are the bandlimited impulse responses we aim at recovering. We assume that the source signatures aᵢ(t) are known. By crosscorrelating the data with one of the source signatures, say, aₖ(t), we arrive at

$$\begin{matrix}\begin{matrix}{Q}_{k} ( {x}_{r} , t ) = {a}_{k} ( - t ) * P ( {x}_{r} , t ) \\ = {w}_{kk} ( t ) * {H}_{k} ( {x}_{r} , t ) + {\sum }_{i = 1 , i \neq k}^{M} {w}_{ki} ( t ) * {H}_{i} ( {x}_{r} , t ) \\ = {U}_{k} ( {x}_{r} , t ) + {U}_{k}^{′} ( {x}_{r} , t ) ,\end{matrix} \\ where & ( 1.83 ) \\ {U}_{k} ( {x}_{r} , t ) = {w}_{kk} ( t ) * {H}_{k} ( {x}_{r} , t ) & ( 1.84 ) \\ {U}_{k}^{′} ( {x}_{r} , t ) = {\sum }_{i = 1 , i \neq k}^{M} {w}_{ki} ( t ) * {H}_{i} ( {x}_{r} , t ) \\ and & ( 1.85 ) \\ {w}_{ik} ( t ) = {\int }_{- ∞}^{∞} {a}_{i} ( r ) {a}_{k} ( r + t ) d r . & ( 1.86 )\end{matrix}$$

We have denoted the data after crosscorrelation as Qₖ(xᵣ,t) and expressed them as a sum of two fields: Uₖ(xᵣ,t) and Uₖ(xᵣ,t).The field Uₖ(xᵣ,t) corresponds to the k-th single-shot gather with a source signature wₖₖ(t), whereas U′ₖ(xᵣ,t) is the multishot gather containing all the single-shot gathers except the k-th single-shot gather. The source signature of the it-th (with i≠k) single-shot gather contained in U′ₖ(xᵣ,t) is now wₖᵢ. As we discussed in previous sections, the source wₖₖ(t) is now stationary, but the source wₖᵢ(t), with i≠k, remain nonstationary signals. The new multishot data Q_{kz}(xᵣ,t) are basically a sum of a nonstationary signal U′ₖ(xᵣ,t) and a stationary signal Uₖ(xᵣ,t). The key idea in our decoding in this subsection is to exploit this difference between U′ₖ(xᵣ,t) and Uₖ(xᵣ,t) in order to separate them from Qₖ(xᵣ,t).

The key difference between stationary and nonstationary signals is the way the frequency bandwidth is spread with time. For a given time window of data large enough such that Fourier transform can be performed accurately, the resulting spectrum from the Fourier transform will contain all the frequencies of stationary data and only a limited number of frequencies of the nonstationary data. Moreover, if the amplitude of the stationary data and those of nonstationary data are comparable, the frequencies associated with the nonstationary tend to have disproportionately high amplitudes because they are actually a superposition of the amplitudes of stationary and nonstationary signals. We here propose to use these anomalies in the amplitude spectra of Qₖ(xᵣ,t) to detect the frequencies associated with the nonstationary signals and filter them out of our spectra. We first take a window of data of a size of, say, 40 traces by 100 samples in time. We denote the data in this window by Qₖ^{(j)}(xᵣ,t), where the index j is used to identify the window of the data under consideration. We then Fourier-transform Qₖ^{(j)}(xᵣ,t) to obtain Qₖ^{(j)}(xᵣ,ω). We can now compute the following function,

$${A}_{k}^{( i )} ( ω ) ≡ {\sum }_{{x}_{r}} {Q}_{k}^{( j )} ( {x}_{r} , ω ) , \qquad ( 1.87 )$$

which allows us to detect the abnormal frequencies with the presence of nonstationary signal in Qₖ^{(j)}(xᵣ,ω).

Let us return to the detection of abnormal frequencies. We first match the scale of the spectrum of |Aₖ⁽ⁱ⁾(ω)| to that |wₖₖ⁽ⁱ⁾(ω)|. Suppose that |Aₖ⁽ⁱ⁾(ω)| is the scaled spectrum. We then define a new spectrum as follows:

$${\hat{Q}}_{k}^{( j )} ( {x}_{r} , ω ) = \{ \begin{matrix}{Q}_{k}^{( j )} ( {x}_{r} , ω ) & if \vert {\hat{A}}_{k}^{( i )} ( ω ) \vert < ( 1 + δ ) \vert {w}_{kk}^{( i )} ( ω ) \vert \\ 0 & if \vert {\hat{A}}_{k}^{( i )} ( ω ) \vert > ( 1 + δ ) \vert {w}_{kk}^{( i )} ( ω ) \vert\end{matrix} . \qquad ( 1.88 )$$

We then use F-X interpolation described in Ikelle and Amundsen (2005) to recover a field quite close to Uₖ(xᵣ,ω). The results shows that the resulting data, after inverse window-Fourier transform, are indeed quite close to the actual data. However, an even more accurate solution can be obtained by adding it to Qₖ(xᵣ,t) to form an additional mixtures that we will call Q′ₖ(xᵣ,t). Now we have two mixtures; i.e.,

$$( \begin{matrix}{Q}_{k} \\ {Q}_{k}^{′}\end{matrix} ) = ( \begin{matrix}1 & 1 \\ a & 0\end{matrix} ) ( \begin{matrix}{U}_{k} \\ {U}_{k}^{′}\end{matrix} ) , \qquad ( 1.89 )$$

where α is a constant. We can then use the ICA-decoding algorithm to recover Uₖ₁ and Uₖ₂ For greater accuracy, we can consider solving this ICA by moving window so that small variations of α with time can be allowed.

The algorithm can be implemented as follows:

(1) Collect single-mixture data P(xᵣ,t) with a multishooting array made of I different nonstationary source signatures, a₁(t), . . . , a_{I}(t).

(2) Set the counter to i=b(t)=a₁(t) and U(xᵣ,t)=P(xᵣ,t).

(3) Crosscorrelate aᵢ(t) and U(xᵣ,t) to produce Q(xᵣ,t). The data Q(xᵣ,t) are now a mixture of stationary and nonstationary signal.

(4) Separate the nonstationary signal from the stationary signals. We denote the nonstationary signal by Qₙₛ(xᵣ,t) and the stationary signal by Qₛₜ(xᵣ,t).

(5) Construct a two-dimensional ICA using Q(xᵣ,t) and Qₛₜ(xᵣ,t) as the mixtures.

(6) Apply ICA to obtain the single-shot gather Pᵢ(xᵣ,t) and a new mixture made of the remaining single-shot gathers that we denote U(xᵣ,t).

(7) Reset the counter, i←i+1, and go to step (3) unless i=I.

### 8.7 Algorithm #11

One can also use the same idea by making the delay of one shot stationary and other one nonstationary. Basically the concept we used in the algorithm that we just described for the time axis is extended to the receiver axes.

The basic idea is to introduce the delay between the initial time of the firing shots in such a way that when data are sorted into receiver gathers or CMP gathers, the signal associated with some of the shot points can treated spatially as nonstationary signal whereas the signals associated with other are shots are treat as stationary signal. We can then filter the nonstationary signal by Fourier-transforming data and zeroing the amplitude below a certain threshold.

Let us consider a case of two simultaneous sources to illustrate this technique. The initial firing of the source S₁ is constant at to throughout the survey, whereas the initial firing time of source S₂ alternates between t₁ and t₂ from shot to shot. When data are sorted out into receiver gathers or CMP gathers, we can see that the events associated with S₁ are stationary whereas events associated with S₁ vary rapidly and are nonstationary. Our approach is to filter out the nonstationary events and we can recover the stationary signals which correspond to a single source. Alternatively, we can filter out the stationary signal and then recover the second source.

(1) Collect single-mixture data with a multishooting array made of I identical stationary source signatures, which are fired at different times τᵢ(xₛ). These firing times are chosen so that the event of one single-shot gather of multishot gather can be stationary, whereas those of other single-shot gathers of a multishot gather are nonstationary. Thus we can use the differences between stationary and nonstationary signals to create a new mixture (virtual mixture).

(2) Sort the data into receiver or CMP gathers.

(3) Transform the receiver gathers to the F-K or K-T (wavenumber-time) domain.

(4) Separate the nonstationary signals from the stationary signals. We denote the nonstationary signal by Qₙₛ and the stationary signal by Qₛₜ

(5) Construct a two-dimensional ICA using Q(xᵣ,t) and Qₛₜ(xᵣ,t) are the mixtures.

(6) Apply ICA to obtain the single gather Pᵢ and a new mixture made of remaining single-shot gathers that we denote U(xᵣ,t).

(7) Readjust the time delay so that events associated with one shot become stationary, whereas the events associated with the other shots remain nonstationary

(8) Go to step (4) unless the output of step (6) is two single-shot gathers.

### 8.8 Algorithm #12

We consider an acquisition with two simultaneous sources, one a monopole and the other a dipole. And we record the pressure and vertical component of particle displacements. So we can form a linear system as follows:

P(kₓ,ω)=P₁(kₓ,ω)+α(kₓ,ω)P₂(kₓ,ω) (1.90)

V(kₓ,ω)=α′(kₓ,ω)P₁(kₓ,ω)+β(kₓ,ω)P₂(kₓ,ω), (1.91)

The deghosting parameters α(kₓ,ω), α′(kₓ,ω), β(kₓ,ω) can be found in Chapter 9 of Ikelle and Amundsen (2005). We can then reconstruct P₁(kₓ,ω) and P₂(kₓ,ω) and one of the ICA algorithms (number 1,2,3, or 4) to decode data. One can extend this approach to three or four sources by using a horizontal source and recording horizontal components of the particle velocity.

(1) Collect a single mixture of multicomponent data P(xᵣ,t) with a multishooting array made of I/2 monopole sources and I/2 dipole sources.

(2) Solve the system of equation in (1.90)-(1.91) to recover single-shot gathers.

### 8.9 Algorithm #13

For cases in which the sources are located near the sea surface, the up-down separation (see Ikelle and Amundsen, 2005) can be used to create two virtual mixtures: as follows:

d(xᵣ,t)=α₁₁(t)x₁(xᵣ,t)+α₁₂(t)x₂(xᵣ,t),

u(xᵣ,t)=α₂₁(t)x₁(xᵣ,t)+α₂₂(t)x₂(xᵣ,t).

where αᵢⱼ(t) are short-duration function (with sometime slight lateral variations), where d(xᵣ,t) is the downgoing wavefield, and where u(xᵣ,t) is the upgoing wavefield. The single-shot gathers are x₁(xᵣ,t) and x₂(xᵣ,t). We can then decode data using the algorithm of convolutive mixtures (algorithm #4) to decode data.

One can extend this method to four or more simultaneous shots by using the up/down separation of both the pressure and the particular velocity. Here is an illustrations of these equations for the pressure and the vertical components of the particular velocity:

dₚ(xᵣ,t)=α₁₁(t)x₁(xᵣ,t)+α₁₂(t)x₂(xᵣ,t)+α₁₃(t)x₂(xᵣ,t)+α₁₄(t)x₄(xᵣ,t),

d_{ν}(xᵣ,t)=α₂₁(t)x₁(xᵣ,t)+α₂₂(t)x₂(xᵣ,t)+α₂₃(t)x₂(xᵣ,t)+α₂₄(t)x₄(xᵣ,t),

uₚ(xᵣ,t)=α₃₁(t)x₁(xᵣ,t)+α₃₂(t)x₂(xᵣ,t)+α₃₃(t)x₂(xᵣ,t)+α₃₄(t)x₄(xᵣ,t),

u_{ν}(xᵣ,t)=α₄₁(t)x₁(xᵣ,t)+α₄₂(t)x₂(xᵣ,t)+α₄₃(t)x₂(xᵣ,t)+α₄₄(t)x₄(xᵣ,t).

(1) Collect a single mixture of multicomponent data P(xᵣ,t) with a multishooting array made of I sources.

(2) Perform an up/down separation.

(3) Apply the ICA algorithm (number 4) by treating the upgoing and downgoing wavefields as different convolutive mixtures.

Those skilled in the art will have no difficulty devising myriad obvious variants and improvements upon the invention without undue experimentation and without departing from the invention, all of which are intended to be encompassed within the claims which follow.

1. A method of analysis of seismic data, the method comprising the steps of:
collecting a single mixture of multicomponent data P(xᵣ,t) with a multishooting array made of I/2 monopole sources and I/2 dipole sources;
forming a linear system of equations between the components of multishot data and the desired single-shot data; and
solving the system of equations to recover single-shot gathers.

2. A method of analysis of seismic data, the method comprising the steps of:
collecting a single mixture of multicomponent data P(xᵣ,t) with a multishooting array made of I sources;
performing an up/down separation to produce evenly determined equations of convolutive mixtures; and
applying an ICA algorithm by treating the upgoing and downgoing wavefields as different convolution mixtures.

3. A method of analysis of seismic data, the method comprising the steps of:
collecting multisweep-multishot data in at least two mixtures using two shooting boats, or any other acquisition devices;
arranging the entire multishot gather (or any other gather type) in random variables Yᵢ, with i varying from 1 to I;
whitening the data Y to produce Z;
computing cumulant matrices Q^{(p,q)} of the whitened data vector Z;
initializing the auxiliary variables W′=I;
choosing a pair of components i and j;
computing θ₄^{(ij)} using Q^{(p,q)} and deducing
$${θ}_{max}^{( ij )} ;$$
if
$${θ}_{max}^{( ij )} > ɛ ,$$
constructing W^{(ij)} and updating W′←W^{(ij)}W′;
diagonalizing cumulant matrices: Q^{(p,q)}←W^{(ij)}Qz^{(p,q)}[W^{(ij)}]^{T};
returning to the initializing step unless all possible
$${θ}_{max}^{( ij )} \leq ɛ ,$$
with ε<<1; and
reorganizing and resealing properly after the decoding process by using first arrivals or direct-wave arrivals.

4. The method of claim 3 wherein the step of choosing a pair of components i and j is carried out randomly.

5. The method of claim 3 wherein the step of choosing a pair of components i and j is carried out in any given order.

6. A method of analysis of seismic data, the method comprising the steps of:
collecting multisweep-multishot data in at least two mixtures using two shooting boats, or any other acquisition devices;
arranging a gather type in random variables Yᵢ, with i varying from 1 to I;
whitening the data Y to produce Z;
choosing I, the number of independent components, to estimate and set p=1;
initializing wₚ;
doing an iteration of a one-unit algorithm on wₚ;
doing an orthogonalization:
$${w}_{p} = {w}_{p} - {\sum }_{j = 1}^{p - 1} ( {w}_{p}^{T} {w}_{j} ) {w}_{j} ;$$
normalizing wₚ by dividing it by its norm (e.g. wₚ←w/∥w∥);
if wₚ has not converged, returning to the step of doing an iteration;
setting p=p+1; and
if p is not greater than I, returning to the initializing step.

7. The method of claim 6 wherein the step of arranging the gather type comprises arranging the entire multishot gather.

8. A method of analysis of seismic data, the method comprising the steps of:
collecting multisweep-multishot data in at least two mixtures using two shooting boats or any other acquisition devices;
arranging a gather type in random variables Yᵢ, with i varying from 1 to I;
setting the counter to k=1;
select a region of the data in which only single-shot Xᵢ contribute to the data;
computing the kth column of the mixing matrix using the ratios of mixtures;
setting k=k+1, and if k is not greater than I, then returning to the step of selecting a region;
invert the mixing matrix; and
estimating the single-shot gathers as the product of the inverse matrix with the mixtures.

9. The method of claim 8 wherein the step of arranging the gather type comprises arranging the entire multishot gather.

10. A method of analysis of seismic data, the method comprising the steps of:
collecting multisweep-multishot data in at least two mixtures using two shooting boats, or any other acquisition devices;
taking a Fourier transform of the data with respect to time;
choosing a frequency slice of data, Y_{ν};
whitening the frequency slice to produce Z_{ν} and V_{ν};
applying a complex ICA to Z_{ν} and producing W_{ν};
computing B_{ν}=W_{ν}V_{ν} and deducing \hat{B}_{ν}=Diag(B_{ν}⁻¹)B_{ν};
getting the independent components for this frequency slice: \hat{X}_{ν}=\hat{B}_{ν}Y_{ν};
returning to the step of taking a Fourier transform unless all frequency slices have been processed;
using the fact that seismic data are continuous in frequency to produce permutations of the random variables of \hat{X}_{ν} which are consistent for all frequency slices; and
taking the inverse Fourier-transform of the permuted frequency slices with respect to frequency.

11. A method of analysis of seismic data, the method comprising the steps of:
collecting at least two mixtures using either two boats or two source arrays;
estimating the mixing using orientation lines of single-shot gathers in a scatterplot with respect to an independence criterion, the decoded gathers having a covariance matrix and a fourth-order cumulant tensor and having PDFs, the independence criterion based on the fact that the covariance matrix and fourth-order cumulant tensor of the decoded gathers must be diagonal or that a joint PDF of the decoded gathers is a product of the PDFs of the decoded gathers.
decoding the multishot data using a geometrical definition of mixtures in the scatterplot, or using p-norm criterion (with p smaller than or equal to 1) to perform the decoding point by point in the multisweep-multishot data.

12. A method of analysis of seismic data, the method comprising the steps of:
collecting single-mixture data P(xᵣ,t) with a multishooting array made of I shot points, which are fired with Δτ between two consecutive shots;
constructing the data for the first window corresponding to the interval [0, t₁(xᵣ)] of the data P(xᵣ,t) with t₁(xᵣ)=t₀(xᵣ)+Δτ, where t₀(xᵣ) is the first break. We denote these data Q₁(xᵣ,t)=K_{1,1}(xᵣ,t);
setting the counter to i=2, where the index indicates the i-th window, the interval of this window being [t₂(xᵣ), t₃(xᵣ)], with t₃(xᵣ)=t₂(xᵣ)+Δτ;
constructing the data corresponding to the i-th window, denoting these data by
$${Q}_{i} ( {x}_{r} , t ) = {\sum }_{k = 1}^{I} {K}_{i , r} ( {x}_{r} , t ) ,$$
where K_{i,k}(xᵣ,t) is the contribution of the k-th single shot gathers to the multishot data in this window;
shifting and adapting K_{i-1,k-1} to K_{i,k};
using the adapted K_{i-1,k-1} as mixtures in addition to Qᵢ(xᵣ,t), to decode Qᵢ(xᵣ,t) using an ICA technique; and
resetting the counter, i←i+1 and returning to the step of constructing the data corresponding to the i-th window, unless the last window of the data has just been processed.

13. A method of analysis of seismic data, the method comprising the steps of:
collecting a single mixture data with a multishooting array made of I identical stationary source signatures, which are fired at different times τᵢ(xᵢ) and collecting a reference single-shot gather;
adapting this single-shot gather to a nearest single-shot gather in the multishot gather;
using the adapted single-shot gathers as new mixtures in addition to the recorded mixture;
applying the ICA algorithms to decode one single-shot gather and to obtain new mixtures with one single-shot gather; and
unless the output of the applying step is two single-shot gathers, returning to the applying step using the new mixture and the new single-shot gather as reference shot or with the original reference shot.

14. A method of analysis of seismic data, the method comprising the steps of:
collecting single-mixture data with a multishooting array made of I identical stationary source signatures which are fired at different times τᵢ(xₛ), the firing times chosen so that the apparent velocity spectra of single-shot gathers can be significantly different;
sorting the data into receiver or CMP gathers;
transforming the receiver or CMP gathers in the F-K domain;
applying F-K dip filtering to produce an approximate separation of the data into single-shot gathers;
inverse Fourier-transforming the separated single-shot gathers;
using these single-shot receivers gathers as new mixtures in addition to p(xₛ,t); and
producing the final decoded data by using ICA techniques.

15. A method of analysis of seismic data, the method comprising the steps of:
collecting single-mixture data P(xᵣ,t) with a multishooting array made of I different nonstationary source signatures, a₁(t), . . . , a_{I}(t);
setting the counter to i=b(t)=a₁(t) and U(xᵣ,t)=P(xᵣ,t);
crosscorrelating a₁(t) and U(xᵣ,t) to produce Q(xᵣ,t), whereby the data Q(xᵣ,t) are a mixture of stationary and nonstationary signal;
separating the nonstationary signal from the stationary signals, denoting the nonstationary signal by Qₙₛ(xᵣ,t) and the stationary signal by Qₛₜ(xᵣ,t);
constructing a two-dimensional ICA using Q(xᵣ,t) and Qₛₜ(xᵣ,t) as the mixtures;
applying ICA to obtain the single-shot gather Pᵢ(xᵣ,t) and a new mixture made of the remaining single-shot gathers that denoted as U(xᵣ,t);
resetting the counter, i←i+1, and returning to the cross-correlating step unless i=I.

16. A method of analysis of seismic data, the method comprising the steps of:
collecting single-mixture data with a multishooting array made of I identical stationary source signatures, which are fired at different times τᵢ(xₛ), these firing times chosen so that the event of one single-shot gather of multishot gather can be stationary, whereas those of other single-shot gathers of a multishot gather are nonstationary;
sorting the data into receiver or CMP gathers;
transforming the receiver or CMP gathers to the F-K or K-T (wavenumber-time) domain;
separating the nonstationary signals from the stationary signals, denoting the nonstationary signal by Qₙₛ and the stationary signal by Qₛ;
constructing a two-dimensional ICA using Q(xᵣ,t) and Qₛₜ(xᵣ,t) as the mixtures;
applying ICA to obtain the single gather Pᵢ and a new mixture made of remaining single-shot gathers denoted as U(xᵣ,t);
readjusting the time delay so that events associated with one shot become stationary, whereas the events associated with the other shots remain nonstationary;
returning to the separating step unless the output of the applying step is two single-shot gathers.

17. A method of analysis of seismic data, the method comprising the steps of:
collecting multisweep-multishot data in at least two mixtures using two shooting boats or any other acquisition devices;
arranging a gather type in random variables Yᵢ, with i varying from 1 to I;
whitening the data Y to produce Z;
initializing auxiliary variables W′=I and Z′=Z;
choosing a pair of components i and j;
computing θ₄^{(ij)} using the cumulants of Z′ and deducing θₘₐₓ^{(ij)} thereby;
if θₘₐₓ^{(ij)}>, ε, constructing W^{(ij)} and updating W′←W^{(ij)}W′.
rotating the vector Z′: Z′←W^{(ij)}Z′;
returning to the choosing step unless all possible θₘₐₓ^{(ij)}≦ε, with ε<<1; and
reorganizing and resealing properly after the decoding process by using first arrivals or direct-wave arrivals.

18. The method of claim 17 wherein the step of arranging the gather type comprises arranging the entire multishot gather.

19. The method of claim 17 wherein the step of choosing a pair of components i and j is carried out randomly.

20. The method of claim 17 wherein the step of choosing a pair of components i and j is carried out in any given order.

21. A method of subsurface exploration, the method carried out with respect to imaging software for analyzing single-shot data and developing imaging results therefrom, the method comprising the steps of:
performing a multi-shot, and collecting multi-shot data;
decoding the multi-shot data, yielding proxy single-shot data;
carrying out analysis of the proxy single-shot data by means of the imaging software, thereby yielding imaging results from the proxy single-shot data.

22. The method of claim 21 wherein the step of performing a multi-shot comprises only a single sweep, the method comprising the additional step, performed between the performing step and the decoding step, of numerically generating an additional sweep from the multi-shot data, the decoding step carried out with respect to the single sweep and the additional numerically generated sweep.

23. A method of subsurface exploration, the method carried out with respect to imaging software for analyzing single-shot data and developing imaging results therefrom, the method comprising the steps of:
acquiring multisweep-multishot data generated from several points nearly simultaneously, carried out onshore or offshore, denoting by K a number of sweeps and by I a number of shot points for each multishot location;
if K=1, numerically generating at least one additional sweep, using time delay reference shot data, multicomponent data;
if K=I, and a mixing matrix is known, performing the inversion of the mixing matrix to recover the single-shot data;
if K=I, and a mixing matrix is not known, using PCA or ICA to recover single-shot data;
if K<I (with K equaling at least 2), then
(i) estimate the mixing using the orientation lines of single-shot gathers in the scatterplot, the independence criterion based on the fact that the covariance matrix and fourth-order cumulant tensor of the decoded gathers must be diagonal or that the joint PDF of the decoded gathers is the product of the PDFs of the decoded gathers; and
(ii) decode the multishot data using the geometrical definition of mixtures in the scatterplot, or using p-norm criterion (with p smaller or equals to 1) to perform the decoding point by point in the multisweep-multishot data.
